(19) United States
(12) Patent Application Publication
(10) Pub. No.: US 2024/0171979 A1
(43) Pub. Date: May 23, 2024

(54) DETECTING ANOMALOUS BEHAVIOUR IN AN EDGE COMMUNICATION NETWORK

(71) Applicant: Telefonaktiebolaget LM Ericsson (publ), Stockholm (SE)

(72) Inventors: Mohamed NAILI, Montreal (CA); Paulo FREITAS DE ARAUJO FILHO, Recife Pernambuco (BR); Georges KADDOUM, Laval (CA); Emmanuel THEPIE FAPI, Cote-Saint-Luc (CA)

(21) Appl. No.: 18/576,536

(22) PCT Filed: Jul. 15, 2021
(86) PCT No.: PCT/IB2021/056388

§ 371 Date: Jan. 4, 2024

(51) Int. Cl. H04W 12/121; H04L 9/40; H04L 41/16

(52) U.S. Cl. CPC H04W 12/121; H04L 41/16; H04L 63/1425

(57) ABSTRACT

A method for detecting anomalous behaviour in an edge communication network. The method is performed by a hierarchical system of detection nodes deployed in the edge communication network. A plurality of first detection nodes at a first hierarchical level of the system obtain samples of an incoming traffic flow from a wireless device, use an ML model to generate an anomaly detection score representative of a probability that the incoming traffic flow is associated with anomalous behaviour, provide the anomaly detection score to a detection node at a higher hierarchical level of the system, and, if the anomaly detection score is above a threshold value, initiate action to take defensive action with respect to the incoming traffic flow.

### TECHNICAL FIELD

The present disclosure relates to methods for detecting anomalous behaviour in an edge communication network. The present disclosure also relates to detection and administration nodes of a distributed system, and to a computer program and a computer program product configured, when run on a computer to carry out methods for detecting anomalous behaviour in an edge communication network.

### BACKGROUND

EDGE communication networks are particularly vulnerable to distributed attacks, and detecting and defending against such attacks is an ongoing challenge.

The 5^{th} generation of 3GPP communication networks (5G) introduces network slicing with configurable Quality of Service (QoS) for individual network slices. FIG. 1 illustrates different QoS flows within two example network slices. Communication Service Providers, such as Mobile Virtual Network Operators (MVNOs) can exploit the possibilities afforded by network slicing to improve profitability of services and quality of experience for users. In order to secure the network and services, a range of security functionalities may be required, including Data protection (confidentiality and integrity protection of data), Network security (Firewall, Intrusion detection, Security Gateway, traffic separation), Hardware and Platform Security, Logging, Monitoring and Analytics, Key and Certificate Management, and Authentication and Authorization.

An active development area in 5G architecture is Multi-access Edge Computing (MEC). FIG. 2 illustrates the 3GPP MEC integrated architecture for development. As illustrated in FIG. 2, the architecture comprises two parts: the 5G Service-Based Architecture (SBA) on the left and a MEC reference architecture on the right. The SBA comprises functions including Access and Mobility Management Function (AMF), Session Management Function (SMF), Network Slice Selection Function (NSSF), Network Repository Function (NRF), Unified Data Management (UDM), Policy Control Function (PCF), Network Exposure Function (NEF), Authentication Server Function (AUSF), and User Plane Function (UPF).

The MEC reference architecture comprises two main levels: System level and host level. The System level includes the MEC orchestrator (MECO), which manages information on deployed MEC hosts (servers), available resources, MEC services, and topology of the entire MEC system. The MEC orchestrator also has other roles related to applications, such as triggering application instantiation (with MEC host selection), relocation and termination, and on-boarding of application packages. The host level includes the MEC Platform Manager (MPF), the virtualization infrastructure manager (VIM), and the MEC host. Application life cycles, rules and requirements management are among the core functions of the MPF, which requires communication with the VIM. The VIM, besides sending fault reports and performance measurements, is responsible for allocating virtualized resources, preparing the virtualization infrastructure to run software images, provisioning MEC applications, and monitoring application faults and performance. The MEC host, on which MEC applications will be running, comprises two main components: the virtualization infrastructure and the MEC platform. The virtualization infrastructure provides the data plane functionalities needed for traffic rules (coming from the MEC platform) and steering the traffic among applications and networks. The MEC platform provides functionalities to run MEC applications on a given virtualization infrastructure.

Security for MEC technologies is an active research field. As a consequence of virtualisation, and of deployment changes which bring network functions to the edge, a range of new threats have been identified in relation to MEC technologies. Some of these are physical, and others relate to known security issues for virtual environments, including isolation between virtual machines. Edge cloud related risks include, inter alia, data theft, illegal access, malicious programs such as viruses, and Trojans which can lead to data leakage and MEC application damages such as deletion. Data leakage, transmission interception, and tampering are also potentially critical threats, either on the level of User-plane data or MEC platform communication with management systems, core network functions or third party applications.

Several approaches to the above noted challenges have been proposed, including a Slice-aware trust zone presented by Dimitrios Schinianakis et al. in Security Considerations in 5G Networks: A Slice-Aware Trust Zone Approach, 2019 IEEE Wireless Communications and Networking Conference (WCNC), 15-18 Apr. 2019, Merrakesh—Morroco. A Slice-aware trust region is a logical area of infrastructure and services where a certain level of security and trust is required. Other works seek to exploit the potential of Deep Learning networks to deal with cybersecurity in 5G, including deep learning-based anomaly detection systems. In https://www.researchgate.net/profile/Manuel Perez25/publication/324970373 Dynamic management of a deep learning:

based anomaly detection system for 5G networks/links/5afd3f2ca6fdcc3a5a275a6a/Dynamic-management-of-a-deep-learning-based-anomaly-detection-system-for-5G-networks.pdf, Lorenzo Fernandez Maimo et al. propose a MEC oriented solution based on deep learning in 5G mobile networks to detect network anomalies in real-time and in an autonomic way. The main components of the system architecture include a flow collector, anomaly Symptoms detector and Network anomaly detection. The flow collector collects flows and extract features, which are then input to the Anomaly Symptoms detector, which uses a Deep neural network and acts as an encoder. The Anomaly symptoms detector provides an input tensor to the Network Anomaly detector which plays the role of a classifier, based on Long Short Term Memory (LSTM).

### SUMMARY

It is an aim of the present disclosure to provide methods, nodes and a computer readable medium which at least partially address one or more of the challenges discussed above. It is a further aim of the present disclosure to provide methods, nodes and a computer readable medium which cooperate to enable detection of distributed attacks which may be on different geographical scales and on different levels, including for example QoS level and Network Slice level.

According to a first aspect of the present disclosure, there is provided a computer implemented method for detecting anomalous behaviour in an edge communication network. The method is performed by a hierarchical system of detection nodes deployed in the edge communication network. The method comprises a plurality of first detection nodes at a first hierarchical level of the system performing the steps of obtaining samples of an incoming traffic flow from a wireless device to the communication network, using a Machine Learning (ML) model to generate, based on the received samples, an anomaly detection score representative of a probability that the incoming traffic flow is associated with anomalous behaviour in the communication network, providing the anomaly detection score to a detection node at a higher hierarchical level of the system, and, if the anomaly detection score is above a threshold value, initiating a defensive action with respect to the incoming traffic flow. The method further comprises a second detection node at a higher hierarchical level of the system performing the steps of obtaining, from a plurality of first detection nodes, a plurality of anomaly detection scores, each anomaly detection score generated by a first detection node for a respective incoming traffic flow from a wireless device to the communication network, using a Machine Learning (ML) model to generate, based on the obtained anomaly detection scores, a distributed anomaly detection score representative of a probability that the incoming traffic flows are associated with a distributed pattern of anomalous behaviour in the communication network, and, if the distributed anomaly detection score is above a threshold value, initiating a defensive action with respect to at least one of the incoming traffic flows.

According to another aspect of the present disclosure, there is provided a computer implemented method for facilitating detection of anomalous behaviour in an edge communication network. The method is performed by a detection node that is a component of a hierarchical system of detection nodes deployed in the edge communication network. The method comprises obtaining samples of an incoming traffic flow from a wireless device to the communication network, and using a Machine Learning (ML) model to generate, based on the received samples, an anomaly detection score representative of a probability that the incoming traffic flow is associated with anomalous behaviour in the communication network. The method further comprises providing the anomaly detection score to a detection node at a higher hierarchical level of the system, and, if the anomaly detection score is above a threshold value, initiating a defensive action with respect to the incoming traffic flow.

According to another aspect of the present disclosure, there is provided a computer implemented method for facilitating detection of anomalous behaviour in an edge communication network. The method is performed by a detection node that is a component of a hierarchical system of detection nodes deployed in the edge communication network. The method comprises obtaining, from a plurality of detection nodes at a lower hierarchical level of the system, a plurality of anomaly detection scores, each anomaly detection score generated by a lower level detection node for a respective at least one incoming traffic flow from a wireless device to the communication network. The method further comprises using a Machine Learning (ML) model to generate, based on the obtained anomaly detection scores, a distributed anomaly detection score representative of a probability that the incoming traffic flows are associated with a distributed pattern of anomalous behaviour in the communication network. The method further comprises, if the distributed anomaly detection score is above a threshold value, initiating a defensive action with respect to at least one of the incoming traffic flows.

According to another aspect of the present disclosure, there is provided a computer implemented method for facilitating detection of anomalous behaviour in an edge communication network. The method is performed by an administration node of a hierarchical system of detection nodes deployed in the edge communication network. The method comprises obtaining from a detection node in the system a defensive instruction requesting a defensive action with respect to at least one incoming traffic flow from a wireless device to the edge communication network, and, responsive to the received defensive instruction, causing a defensive action to be carried out with respect to at least one incoming traffic flow from a wireless device to the edge communication network. The defensive action may comprise causing the at least one incoming traffic flow to be blocked from accessing the edge communication network.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one or more of aspects or examples of the present disclosure.

According to another aspect of the present disclosure, there is provided a detection node for facilitating detection of anomalous behaviour in an edge communication network, wherein the detection node is a component of a hierarchical system of detection nodes deployed in the edge communication network. The detection node comprises processing circuitry configured to cause the detection node to obtain samples of an incoming traffic flow from a wireless device to the communication network. The processing circuitry is further configured to cause the detection node to use a Machine Learning (ML) model to generate, based on the received samples, an anomaly detection score representative of a probability that the incoming traffic flow is associated with anomalous behaviour in the communication network. The processing circuitry is further configured to cause the detection node to provide the anomaly detection score to a detection node at a higher hierarchical level of the system, and, if the anomaly detection score is above a threshold value, a defensive action with respect to the incoming traffic flow.

According to another aspect of the present disclosure, there is provided a detection node for facilitating detection of anomalous behaviour in an edge communication network, wherein the detection node is a component of a hierarchical system of detection nodes deployed in the edge communication network. The detection node comprises processing circuitry configured to cause the detection node to obtain, from a plurality of detection nodes at a lower hierarchical level of the system, a plurality of anomaly detection scores, each anomaly detection score generated by a lower level detection node for a respective at least one incoming traffic flow from a wireless device to the communication network. The processing circuitry is further configured to cause the detection node to use a Machine Learning (ML) model to generate, based on the obtained anomaly detection scores, a distributed anomaly detection score representative of a probability that the incoming traffic flows are associated with a distributed pattern of anomalous behaviour in the communication network. The processing circuitry is further configured to cause the detection node to, if the distributed anomaly detection score is above a threshold value, initiate a defensive action with respect to at least one of the incoming traffic flows.

According to another aspect of the present disclosure, there is provided an administration node for facilitating detection of anomalous behaviour in an edge communication network, wherein the administration node is a component part of a hierarchical system of detection nodes deployed in the edge communication network. The administration node comprises processing circuitry configured to cause the administration node to obtain from a detection node in the system a defensive instruction requesting a defensive action with respect to at least one incoming traffic flow from a wireless device to the edge communication network. The processing circuitry is further configured to cause the administration node to, responsive to the received defensive instruction, cause a defensive action to be carried out with respect to at least one incoming traffic flow from a wireless device to the edge communication network. The defensive action may comprise causing the incoming traffic flow to be blocked from accessing the edge communication network.

Examples of the present disclosure thus provide methods and nodes that cooperate to detect anomalous behaviour, which may be indicative of an attack, at different hierarchical levels. Detections nodes are operable to detect anomalous behaviour at their individual hierarchical level, through the generation of anomaly scores, and to facilitate detection of anomalous behaviour at higher hierarchical levels via reporting of such scores. In this manner, distributed attacks that are orchestrated via behaviour that may only appear anomalous when considered at a certain level of the network can still be detected.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates different QoS flows within two example network slices (reproduced from Paul shepherd, Learn about QoS 5G networks, https://www.awardsolutions.com/portal/shareables/what-is-5G/5G-Training-Online/learn-about-qos-5g-networks-paul-shepherd-0);

FIG. 2 illustrates the 3GPP MEC integrated architecture for development (reproduced from QUOC-VIET PHAM et al, A Survey of Multi-Access Edge Computing in 5G and Beyond: Fundamentals, Technology Integration, and State-of-the-Art., https://www.etsi.org/deliver/etsi gs/mec/001 099/003/02.01.01 60/gs mec003v02010 1p.pdg, and

5.https://www.etsi.org/deliver/etsi_gs/mec/001_099/003/02.01.01_60/gs_mec003v0201 01p.pdf;

FIG. 3 illustrates an example architecture for implementation methods according to the present disclosure;

FIG. 4 is a flow chart illustrating process steps in a computer implemented method for detecting anomalous behaviour in an edge communication network;

FIGS. 5 to 11b show flow charts illustrating process steps in examples of computer implemented methods for facilitating detection of anomalous behaviour in an edge communication network;

FIGS. 12 to 15 are block diagrams illustrating functional modules in examples of a detection node;

FIGS. 16 and 17 are block diagrams illustrating functional modules in examples of an administration node;

FIG. 18 shows an example extract of a “data drift features change matrix” for a given timeseries data;

FIG. 19 illustrates an example data drift feature change tensor;

FIG. 20 is a sequence diagram for an implementation of methods according to the present disclosure in a system for attack detection and prevention;

FIG. 21 illustrates interaction between Flow level, QoS level and Slice level nodes of a given RAN node; and

FIGS. 22 and 23 illustrate training of a QoS level node RL model and Slice level node

### DETAILED DESCRIPTION

Examples of the present disclosure propose to address security vulnerabilities of Edge networks via methods performed by a distributed system of nodes. As a network may be deployed over a large geographical area, methods according to the present disclosure adopt a hierarchical approach, in which detection nodes at a given hierarchical level are responsible for the surveillance of traffic in their area, and detect and defend against attacks happening on their level. This is achieved by calculating an anomaly detection score, on the basis of which a node can decide whether or not incoming traffic is exhibiting a behaviour pattern at their hierarchical level that is associated with an attack attempt. Detection nodes may report their scores to a higher level detection node, on the basis of which the higher level detection node may generate its own anomaly detection score, representing the likelihood of a distributed attack at its hierarchical level. If an attempted distributed attack is detected, system nodes may decide, based on a Reinforcement Learning model and probabilistic approach, which traffic should be subject to defensive actions, including temporarily blockage for a window of time.

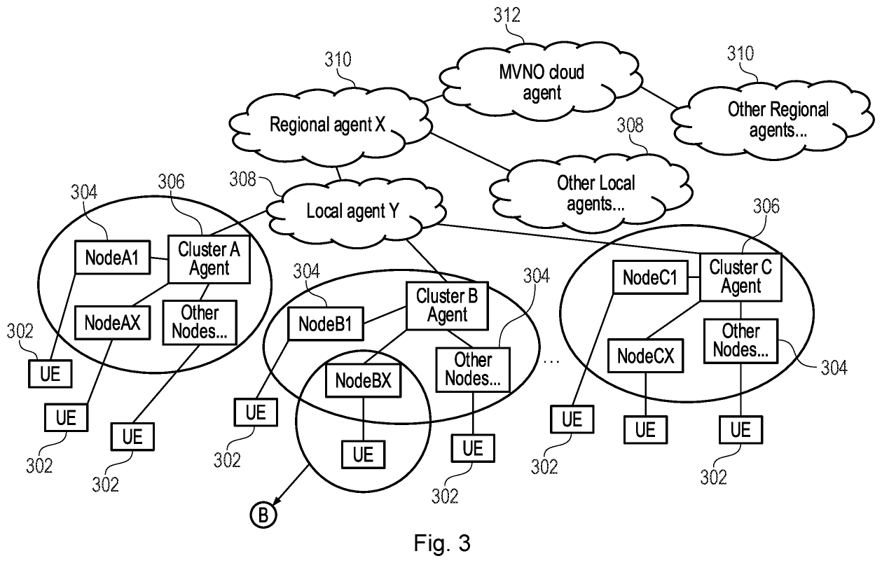

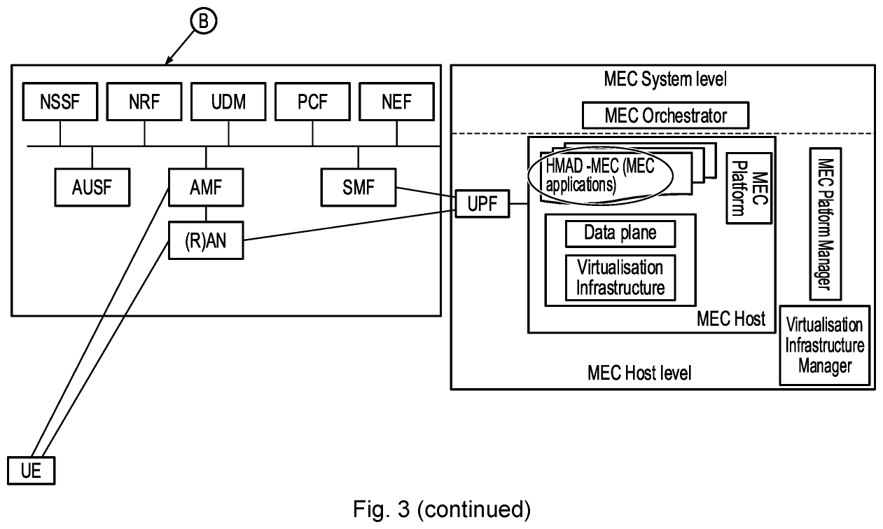

FIG. 3 illustrates an example architecture 300 for implementation of methods according to the present disclosure in the 3GPP MEC deployment architecture discussed above.

Referring to FIG. 3, if a MVNO manages a cluster of network slices in a given geographical area, examples of the present disclosure can support processing of traffic from UEs 302 for detection of anomalies, which may be associated with an attempted attack, on the flow level, QoS level or the slice level. Flow level, QoS level and slice level detection node instances may be deployed on network aggregation points such as C-RAN hub sites 304. Each cluster, which represents for example a set of slices in a relatively small geographical area, can have a cluster level detection node 306 facilitating detection of anomalous behaviour on the cluster slices. In order to provide a consolidated view of the status of all the MNVO's slices within a local area, each set of cluster detection nodes in a given local area may communicate with one local level detection node 308 running on a local office. For a regional view, each group of local nodes may communicate with one regional level detection node 310, running on a regional office. Regional nodes may communicate with a cloud level detection node 312 of the MNVO's distributed system, to allow the MVNO to have an overview of the status of its slices in different regions.

The geographical extent of local and regional areas is configurable according to the operational priorities for a given implementation of the example architecture and methods disclosed herein. Smaller geographical extent of local and regional areas will give higher resolution but also a greater number of nodes in comparison with fewer, larger local and regional areas. The number of cluster nodes per local area, and the number of flow level, QoS level and slice level detection nodes per C-RAN hub site, may be proportional to the number of small cells and the estimated traffic demand per coverage area. Detection nodes at each level may be operable to run methods according to the present disclosure, detecting anomalous behaviour at their own hierarchical level, and contributing to the detection of anomalous behaviour at higher hierarchical levels through reporting of anomaly scores. It will be appreciated that nodes at higher hierarchical levels are consequently able to detect distributed attacks which could not be detected by nodes at lower levels, as the anomalies in behaviour patterns associated with the distributed attack are only apparent when considering the traffic flow of multiple UEs at that particular hierarchical level within the network. Examples of the present disclosure thus provide multi-level protection for an Edge network.

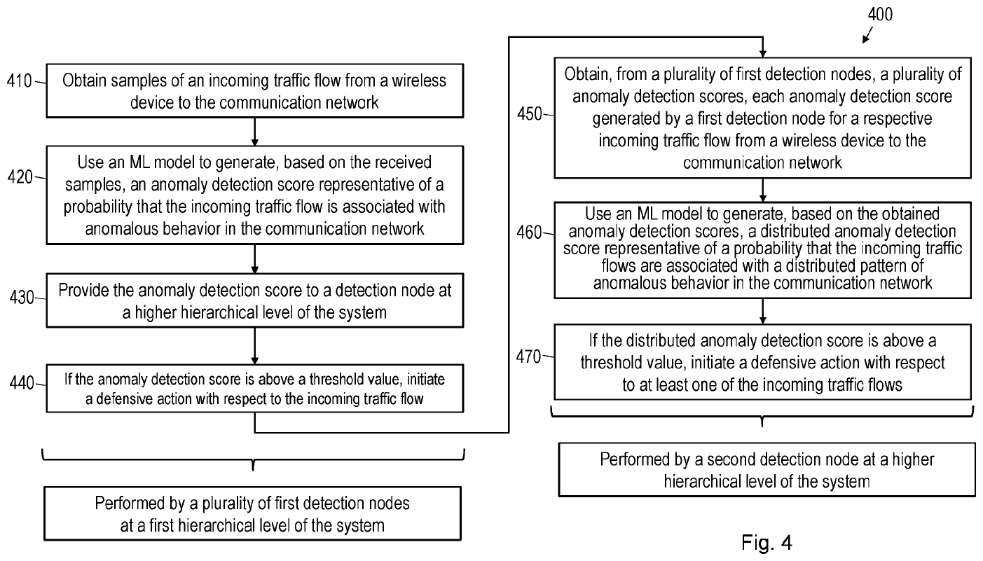

FIG. 4 is a flow chart illustrating process steps in a computer implemented method 400 for detecting anomalous behaviour in an edge communication network. The method is performed by a hierarchical system of detection nodes deployed in the edge communication network. Each detection node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. Detection nodes may for example be implemented in a core network of the communication network, and may be implemented in the Operation Support System (OSS), Orchestration And Management (OAM) system or in a Service Management and Orchestration (SMO) system. In other examples, detection nodes may be implemented in a Radio Access node, which itself may comprise a physical node and/or a virtualized network function that is operable to exchange wireless signals. In some examples, a Radio Access node may comprise a base station node such as a NodeB, eNodeB, gNodeB, or any future implementation of this functionality. Detection nodes may be implemented as functions in an Open Radio Access Network (ORAN) or Virtualised Radio Access Network (vRAN). Each detection node may encompass multiple logical entities, as discussed in greater detail below, and may for example comprise a Virtualised Network Function (VNF).

Referring to FIG. 4, the method 400 comprises a series of steps 410, 420, 430, 440 that are performed by a plurality of first detection nodes at a first hierarchical level of the system. In a first step 410, each of the plurality of first detection nodes obtains samples of an incoming traffic flow from a wireless device to the communication network. Each first detection node then uses a Machine Learning (ML) model in step 420 to generate, based on the received samples, an anomaly detection score representative of a probability that the incoming traffic flow is associated with anomalous behaviour in the communication network. In step 430, each first detection node provides the anomaly detection score to a detection node at a higher hierarchical level of the system. In step 440, if the anomaly detection score is above a threshold value, each first detection node initiates a defensive action with respect to the incoming traffic flow. In some examples, the steps 430 and 440 may be executed in a different order, or in parallel. The method 400 further comprises a series of steps 450, 460, 470 performed by a second detection node at a higher hierarchical level of the system. In step 450, the second node obtains, from a plurality of first detection nodes, a plurality of anomaly detection scores, each anomaly detection score generated by a first detection node for a respective incoming traffic flow from a wireless device to the communication network. The second detection node then, in step 460, uses an ML model to generate, based on the obtained anomaly detection scores, a distributed anomaly detection score representative of a probability that the incoming traffic flows are associated with a distributed pattern of anomalous behaviour in the communication network. In step 470, if the distributed anomaly detection score is above a threshold value, the second detection node, initiates a defensive action with respect to at least one of the incoming traffic flows.

The method 400 thus encompasses actions at two hierarchical levels of a distributed system, with nodes identifying anomalous behaviour that can be detected at their hierarchical level, and reporting their generated anomaly scores to a higher level to contribute to the identification of anomalous behaviour at that higher level. It will be appreciated that the system of detection nodes may comprise multiple hierarchical levels, including flow level, QoS level, slice level, cluster level, local level, regional level and cloud level, as discussed above with reference to the example implementation architecture. Nodes at each hierarchical level may operate substantially as discussed above, detecting anomalous behaviour at their level and reporting to a higher level node.

For the purposes of the present disclosure, it will be appreciated that an ML model is considered to comprise the output of a Machine Learning algorithm or process, wherein an ML process comprises instructions through which data may be used in a training procedure to generate a model artefact for performing a given task, or for representing a real world process or system. An ML model is the model artefact that is created by such a training procedure, and which comprises the computational architecture that performs the task.

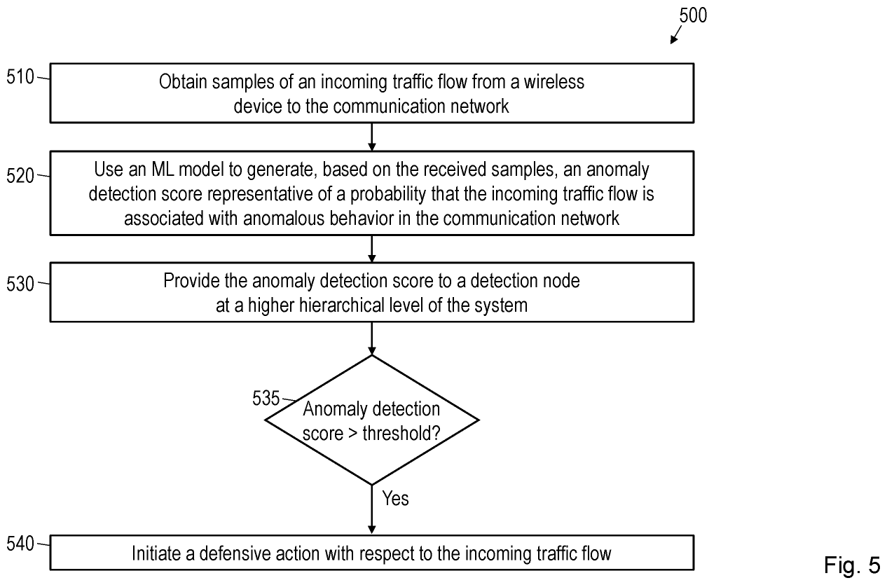

FIGS. 5 to 11 are flow charts illustrating methods that may be performed by detection nodes at different hierarchical levels of a detection system according to examples of the present disclosure. It will be appreciated that the steps of the methods 500 to 1100 may be performed in a different order to that presented below, and may be interspersed with actions executed as part of other procedures being performed concurrently by the nodes. Additionally or alternatively, steps of the methods presented below may be performed in parallel.

FIG. 5 is a flow chart illustrating process steps in a computer implemented method 500 for facilitating detection of anomalous behaviour in an edge communication network. The method 500 is performed by a detection node that is a component of a hierarchical system of detection nodes deployed in the edge communication network. As discussed above with reference to the method 400, the detection node performing the method 500 may comprise a physical or virtual node, and may be implemented in a computer system, computing device or server apparatus and/or in a virtualized environment, for example in a cloud, edge cloud or fog deployment. The detection node may be implemented in a Radio Access node, which itself may comprise a physical node and/or a virtualized network function that is operable to exchange wireless signals. The detection node may be implemented as a function in an Open Radio Access Network (ORAN) or Virtualised Radio Access Network (vRAN). Each detection node may encompass multiple logical entities, and may for example comprise a Virtualised Network Function (VNF). With reference to the example implementation architecture of FIG. 3, the detection node performing the method 500 may comprise a flow level detection node.

Referring to FIG. 5, in a first step 510, the method 500 comprises obtaining samples of an incoming traffic flow from a wireless device to the communication network. In some examples, the samples of an incoming traffic flow may be obtained from a data sampling node via a data dispatching node, which may themselves form part of the distributed hierarchical system. In step 520, the method comprises using an ML model to generate, based on the received samples, an anomaly detection score representative of a probability that the incoming traffic flow is associated with anomalous behaviour in the communication network. The method 500 further comprises, in step 530, providing the anomaly detection score to a detection node at a higher hierarchical level of the system, and in step 540, if the anomaly detection score is above a threshold value initiating a defensive action with respect to the incoming traffic flow. A defensive action may comprise any action that will prevent or inhibit the anomalous behaviour with which the incoming traffic flow may be associated. A defensive action with respect to an incoming traffic flow may for example comprise total blocking of the flow, blocking for a period of time, causing one or more packets of the flow to be dropped, etc. A defensive action with respect to an incoming traffic flow may also comprise load balancing by rerouting live traffic from one server to another, for example if the first server may be under a Distributed Denial of Service attack. The method 500 consequently enables detection of anomalous behaviour at the level of an individual traffic flow, as well as contributing to the detection of anomalous behaviour at higher hierarchical levels via the reporting of the generated anomaly detection score to a higher level detection node.

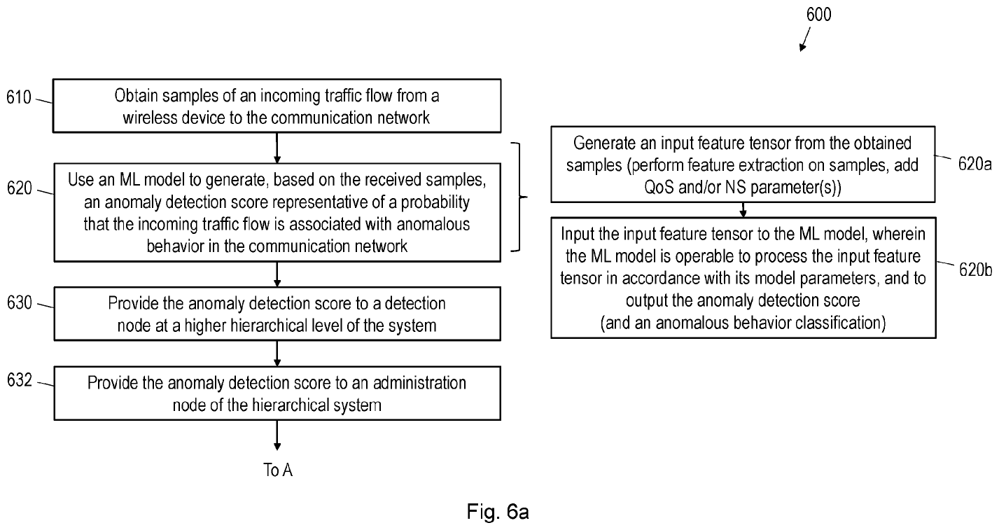

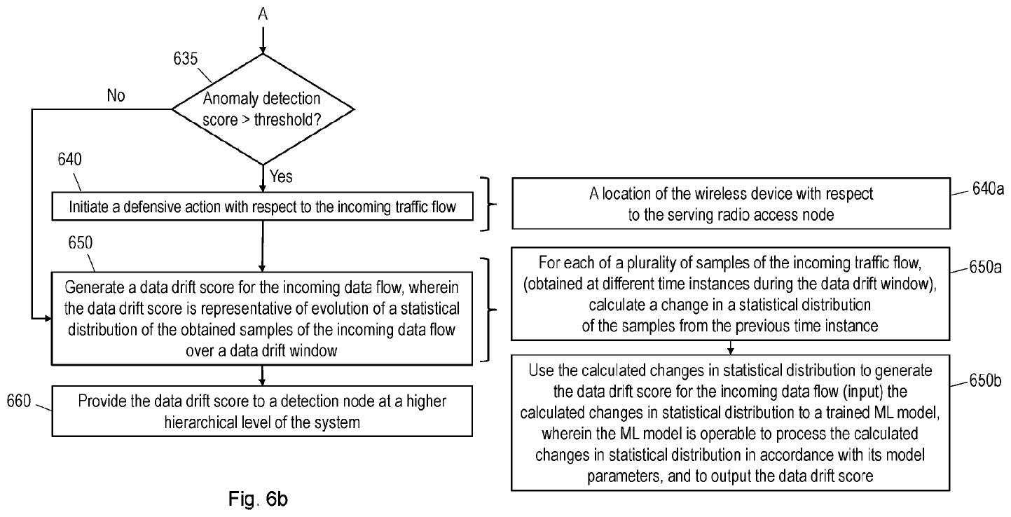

FIGS. 6a and 6b show flow charts illustrating process steps in another example of computer implemented method 600 for facilitating detection of anomalous behaviour in an edge communication network. The method 600 provides various examples of how the steps of the method 500 may be implemented and supplemented to achieve the above discussed and additional functionality. As for the method 500, the method 600 is performed by a detection node that is a component of a hierarchical system of detection nodes deployed in the edge communication network. As discussed above with reference to the method 400, the detection node performing the method 600 may comprise a physical or virtual node, and may be implemented in a computer system, computing device or server apparatus and/or in a virtualized environment, for example in a cloud, edge cloud or fog deployment. The detection node may be implemented in a Radio Access node, which itself may comprise a physical node and/or a virtualized network function that is operable to exchange wireless signals. The detection node may be implemented as a function in an Open Radio Access Network (ORAN) or Virtualised Radio Access Network (vRAN). Each detection node may encompass multiple logical entities, and may for example comprise a Virtualised Network Function (VNF). With reference to the example implementation architecture of FIG. 3, the detection node performing the method 600 may comprise a flow level detection node.

Referring initially to FIG. 6a, in a first step 610, the detection node obtains samples of an incoming traffic flow from a wireless device to the communication network. The detection node then, in step 620, uses an ML model to generate, based on the received samples, an anomaly detection score representative of a probability that the incoming traffic flow is associated with anomalous behaviour in the communication network. As illustrated at in FIG. 6a, this may comprise generating an input feature tensor from the obtained samples in step 620a. Generating an input feature tensor from the obtained samples may be achieved by performing a feature extraction process on the obtained samples, and adding the extracted features to the input tensor. In some examples, additional data collection and cleaning may be performed by the detection node before feature extraction. Features may be extracted for example from the number of packets and their payload size received during a processing window (for example of X milliseconds) from a given wireless device. Examples of features that may be extracted by the detection node for addition to the input tensor may include average, standard deviation, maximum, minimum, sum, median, skewness, kurtosis, 5%, 25%, 75%, 95% quantiles, entropy, etc. In addition to the extracted features, generating an input feature tensor from the obtained samples may further comprise adding to the input tensor at least one of a Quality of Service (QoS) parameter associated with the incoming traffic flow and/or a Network Slice (NS) parameter of a Network Slice to which the incoming traffic flow belongs. Network Slice parameters may comprise KPI values characterising the performance, functionality and/or operation of the slice, and may for example include Throughput, Latency, APIs, Slice Service Type, Slice Differentiator, etc. Quality of Service parameters may be as defined in the relevant 3GPP standards and may for example include the following for 5G networks:
5G QoS Identifier (5GQ1)
Allocation and Retention Priority (ARP)
Reflective QoS Attribute (RQA)
Notification Control
Flow Bit Rates
Aggregate Bit Rates
Default values
Maximum Packet Loss Rate.

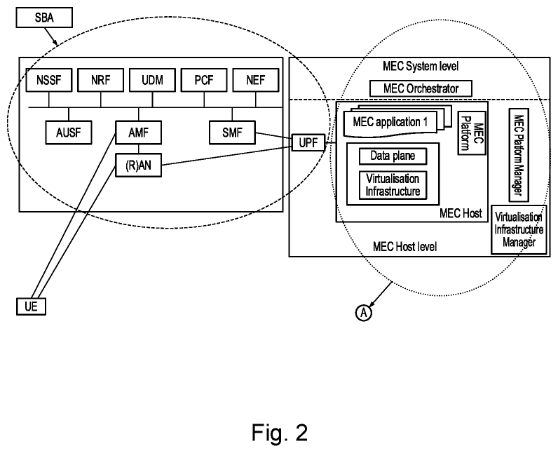

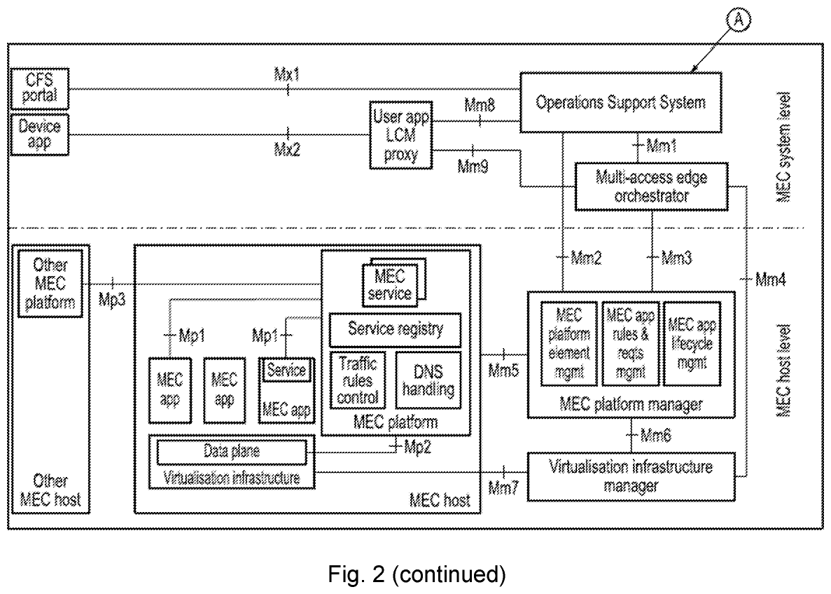

QoS and Network Slice parameters may be obtained from the relevant functions within the edge network architecture, for example the PCF and NSSF of the SBA discussed above with reference to FIG. 2.

Using an ML model to generate an anomaly detection score may further comprise inputting the input feature tensor to the ML model in step 620b, wherein the ML model is operable to process the input feature tensor in accordance with its model parameters, and to output the anomaly detection score. In some examples, the ML model may be further operable to output a classification of anomalous behaviour with which the incoming traffic flow is associated. The outputting of a classification of anomalous behaviour may be dependent upon the output anomaly detection score being above a threshold value, which may be the same threshold value as is used to trigger a defensive action with respect to the incoming traffic flow. The ML model may have been trained using a supervised learning process for example in a cloud location, using training data compiled from a period of historical operation of the edge network. The ML model may comprise a classification model such as Logistic Regression, Artificial Neural Network, Random Forrest, k-Nearest Neighbour, etc.

Referring still to FIG. 6a, after generating the anomaly detection score in step 620, the detection node provides the anomaly detection score to a detection node at a higher hierarchical level of the system in step 630. If the detection node is a flow level detection node, the detection node may for example provide the anomaly detection score to a QoS level detection node of the example implementation architecture discussed above. The detection node may also provide the anomaly detection score to an administration node of the hierarchical system in step 632.

Referring now to FIG. 6b, if the anomaly detection score is above a threshold value, the detection node initiates a defensive action with respect to the incoming traffic flow. The defensive action may comprise blocking the incoming flow, at least temporarily. As illustrated at step 640a, this may comprise providing a defensive instruction to an administration node of the hierarchical system. The defensive instruction may for example comprise an identifier of the incoming traffic flow.

In step 650, regardless of whether or not the anomaly detection score was above the threshold value, the detection node generates a data drift score for the incoming data flow and other incoming data flows received by the detection node, wherein the data drift score is representative of evolution of a statistical distribution of the obtained samples of the incoming data flows over a data drift window. The data drift score may be generated on the basis of a sampled set of the incoming data flows received within a window of time (of configurable length). As illustrated in FIG. 6b, generating a data drift score may first comprise, at step 650a, for each of a plurality of samples of each incoming traffic flow (the samples obtained at different time instances during the data drift window), calculating a change in a statistical distribution of the samples from the previous time instance. This may for example comprise, for each time instance, calculating a plurality of statistical features of the obtained samples, and then calculating a difference in the statistical features between the current time instance and the previous time instance. Generating a data drift score may further comprise using the calculated changes in statistical distribution to generate the data drift score for the incoming data flows in step 650b, for example by inputting the calculated changes in statistical distribution to a trained ML model, wherein the ML model is operable to process the calculated changes in statistical distribution in accordance with its model parameters, and to output the data drift score. The ML model may in some examples be a Convolutional Neural Network (CNN), some other ML model type, or may perform weighting and calculation of a weighted average. In step 660, the detection node provides the data drift score to a detection node at a higher hierarchical level of the system.

The methods 500, 600 may be complemented by methods 700, 800, 900, 1000, 1100 performed by detection nodes at higher hierarchical levels of the system and by an administration node of the system.

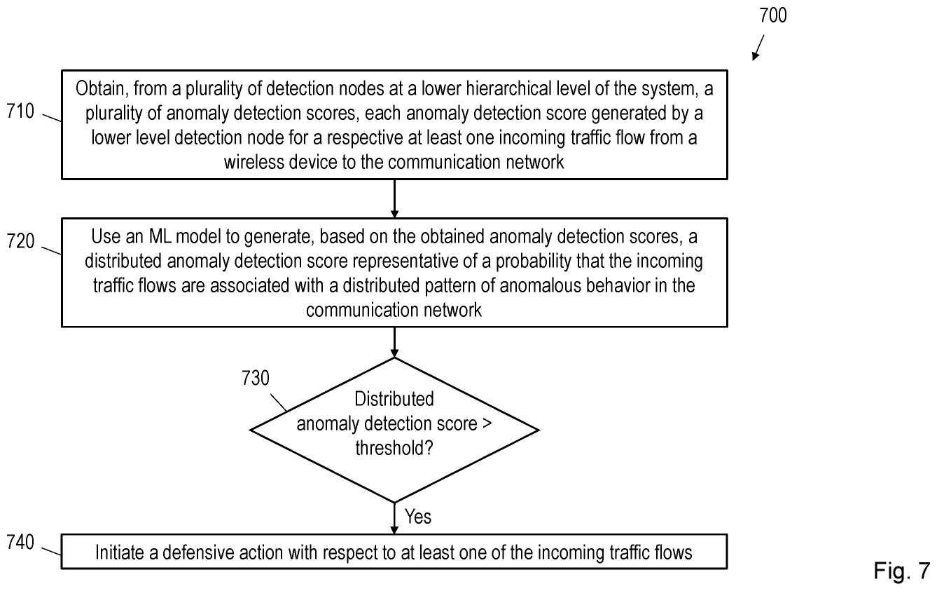

FIG. 7 is a flow chart illustrating process steps in a computer implemented method 700 for facilitating detection of anomalous behaviour in an edge communication network. The method 700 is performed by a detection node that is a component of a hierarchical system of detection nodes deployed in the edge communication network. As discussed above with reference to the method 400, the detection node performing the method 700 may comprise a physical or virtual node, and may be implemented in a computer system, computing device or server apparatus and/or in a virtualized environment, for example in a cloud, edge cloud or fog deployment. The detection node may for example be implemented in a core network of the communication network, and may be implemented in the Operation Support System (OSS), Orchestration And Management (OAM) system or in a Service Management and Orchestration (SMO) system. In other examples, the detection node may be implemented in a Radio Access node, which itself may comprise a physical node and/or a virtualized network function that is operable to exchange wireless signals. The detection node may be implemented as a function in an Open Radio Access Network (ORAN) or Virtualised Radio Access Network (vRAN). The detection node may encompass multiple logical entities and may for example comprise a Virtualised Network Function (VNF). With reference to the example implementation architecture of FIG. 3, the detection node performing the method 700 may comprise a QoS level detection node, a Network Slice level detection node, a local level detection node, a regional level detection node and/or a cloud level detection node.

Referring to FIG. 7, in a first step 710, the method 700 comprises obtaining, from a plurality of detection nodes at a lower hierarchical level of the system, a plurality of anomaly detection scores, each anomaly detection score generated by a lower level detection node for a respective at least one incoming traffic flow from a wireless device to the communication network. The method 700 then comprises, in step 720, using an ML model to generate, based on the obtained anomaly detection scores, a distributed anomaly detection score representative of a probability that the incoming traffic flows are associated with a distributed pattern of anomalous behaviour in the communication network. The method further comprises, if the distributed anomaly detection score is above a threshold value in step 430, initiating a defensive action with respect to at least one of the incoming traffic flows in step 740.

It will be appreciated that the obtained anomaly detection scores may be specific to an individual traffic flow (for example if received from a flow level node carrying out examples of the methods 500, 600), or may themselves be distributed anomaly detection scores (for example if received from a QoS or higher level node). In some examples, the detection node may repeat the steps of the method 700 at each instance of a time window, so that the anomaly detection scores are scores obtained within a single time window, wherein the time window may be specific to the hierarchical level at which the detection node resides in the system. Thus a QoS level detection node may repeat the steps of the method 700 at each “QoS waiting window” for all anomaly detection scores obtained within the preceding QoS waiting window, and a slice level detection node may repeat the steps of the method 700 at each “Slice waiting window” for all anomaly detection scores obtained within the preceding Slice waiting window. The Slice waiting window may be longer than the QoS waiting window, with a local waiting window being longer still, etc. The method 700 enables the detection node to detect anomalous behaviour that can be identified at its hierarchical level, and may also contribute to detection of anomalous behaviour at a higher hierarchical level via the reporting of its generated distributed anomaly detection scores.

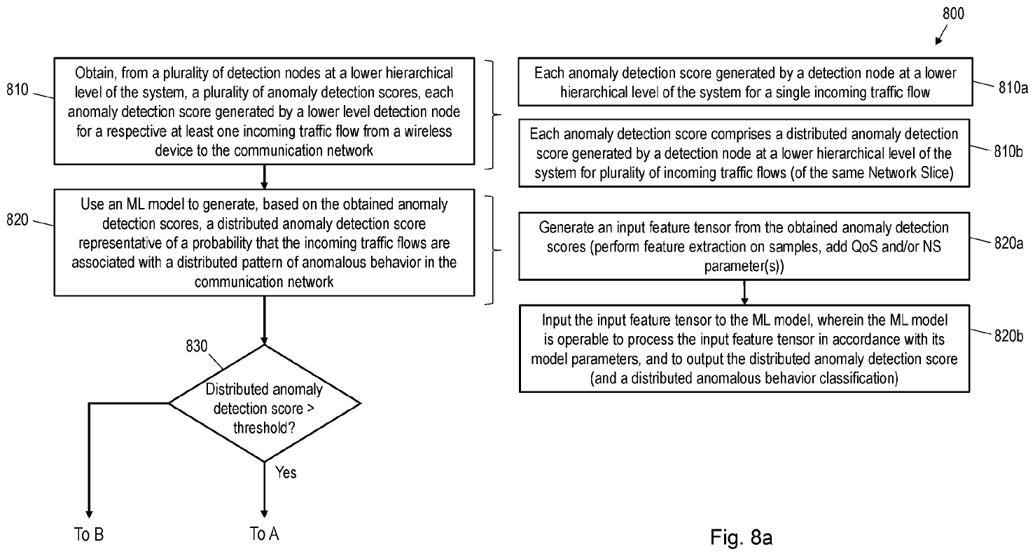

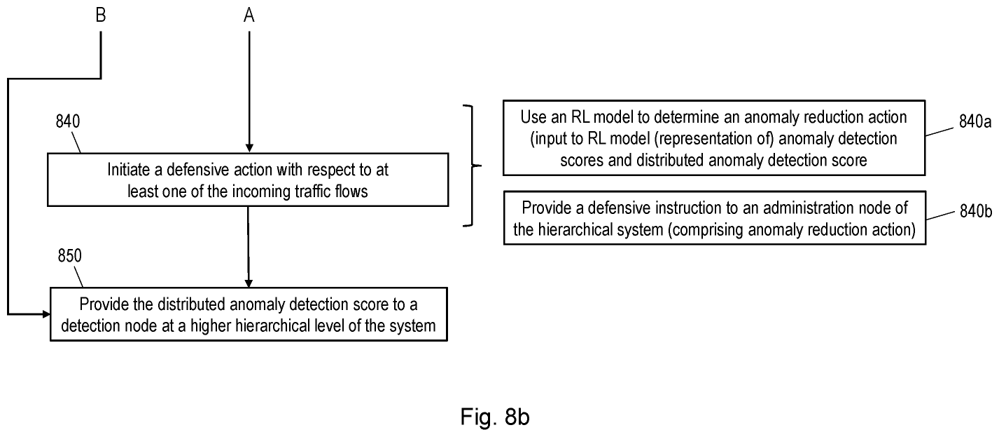

FIGS. 8a and 8b show flow charts illustrating process steps in another example of computer implemented method 800 for facilitating detection of anomalous behaviour in an edge communication network. The method 800 provides various examples of how the steps of the method 700 may be implemented and supplemented to achieve the above discussed and additional functionality. As for the method 700, the method 800 is performed by a detection node that is a component of a hierarchical system of detection nodes deployed in the edge communication network. As discussed above with reference to the method 400, the detection node performing the method 800 may comprise a physical or virtual node, and may be implemented in a computer system, computing device or server apparatus and/or in a virtualized environment, for example in a cloud, edge cloud or fog deployment. The detection node may for example be implemented in a core network of the communication network, and may be implemented in the Operation Support System (OSS), Orchestration And Management (OAM) system or in a Service Management and Orchestration (SMO) system. In other examples, the detection node may be implemented in a Radio Access node, which itself may comprise a physical node and/or a virtualized network function that is operable to exchange wireless signals. The detection node may be implemented as a function in an Open Radio Access Network (ORAN) or Virtualised Radio Access Network (vRAN). The detection node may encompass multiple logical entities and may for example comprise a Virtualised Network Function (VNF). With reference to the example implementation architecture of FIG. 3, the detection node performing the method 800 may comprise a QoS level detection node, a Network Slice level detection node, a local level detection node, a regional level detection node and/or a cloud level detection node.

Referring initially to FIG. 8a, in a first step 810, the detection node obtains, from a plurality of detection nodes at a lower hierarchical level of the system, a plurality of anomaly detection scores, each anomaly detection score generated by a lower level detection node for a respective at least one incoming traffic flow from a wireless device to the communication network. As illustrated at 810a, in some examples, each of the obtained anomaly detection scores comprises an anomaly detection score generated by a detection node at a lower hierarchical level of the system for a single incoming traffic flow. This may be the case if the detection node performing the method 800 is a QoS level detection node of the example implementation architecture of FIG. 3. In other examples, as illustrated at 810b, each of the obtained anomaly detection scores comprises a distributed anomaly detection score generated by a detection node at a lower hierarchical level of the system for plurality of incoming traffic flows. This may be the case if the detection node performing the method 800 is a Slice level, local level, regional level, or cloud level detection node of the example implementation architecture of FIG. 3. In the case of obtained anomaly detection scores comprising distributed anomaly detection scores, each generated by a detection node at a lower hierarchical level of the system for plurality of incoming traffic flows, all of the pluralities of incoming traffic flows, for which each obtained distributed anomaly detection score is generated, may belong to the same network slice.

In step 820, the detection node uses an ML model to generate, based on the obtained anomaly detection scores, a distributed anomaly detection score representative of a probability that the incoming traffic flows are associated with a distributed pattern of anomalous behaviour in the communication network. As illustrated at in FIG. 8a, this may comprise generating an input feature tensor from the obtained anomaly detection scores in step 820a. Generating an input feature tensor from the obtained anomaly detection scores may be achieved by performing a feature extraction process on the obtained anomaly detection scores, and adding the extracted features to the input tensor. In some examples, additional data collection and cleaning may be performed by the detection node before feature extraction. Examples of features that may be extracted by the detection node for addition to the input tensor may include average, standard deviation, maximum, minimum, sum, median, skewness, kurtosis, 5%, 25%, 75%, 95% quantiles, entropy, etc. of the obtained anomaly detection scores. In addition to the extracted features, generating an input feature tensor from the obtained samples may further comprise adding to the input tensor at least one of a Quality of Service (QoS) parameter associated with the incoming traffic flows to which the obtained anomaly detection scores apply, and/or a Network Slice (NS) parameter of a Network Slice to which the incoming traffic flows belong, as discussed in greater detail with reference to method 600.

Using an ML model to generate a distributed anomaly detection score may further comprise inputting the input feature tensor to the ML model in step 820b, wherein the ML model is operable to process the input feature tensor in accordance with its model parameters, and to output the distributed anomaly detection score. In some examples, the ML model may be further operable to output a classification of anomalous behaviour with which the incoming traffic flow is associated. The outputting of a classification of anomalous behaviour may be dependent upon the output distributed anomaly detection score being above a threshold value, which may be the same threshold value as is used to trigger action to block at least one of the incoming traffic flows. The ML model may have been trained using a supervised learning process for example in a cloud location, using training data compiled from a period of historical operation of the edge network. The ML model may comprise a classification model such as Logistic Regression, Artificial Neural Network, Random Forrest, k-Nearest Neighbour, etc.

In step 830, the detection node checks whether or not the generated distributed anomaly detection score is above a threshold value. Referring to FIG. 8b, if the generated distributed anomaly detection score is above a threshold value, the detection node initiates a defensive action with respect to at least one of the incoming traffic flows. The defensive action may comprise blocking at least one of the incoming traffic flows, at least temporarily.

As illustrated at step 840a, initiating a defensive action with respect to at least one of the incoming traffic flows may comprise using a Reinforcement Learning (RL) model to determine an anomaly reduction action, based on the obtained anomaly detection scores and on the generated distributed anomaly detection score. The anomaly reduction action comprises a reduction in the sum of the obtained anomaly detection scores that is predicted to cause the distributed anomaly detection score to fall below the threshold value. This step may be achieved by inputting a representation of the obtained anomaly detection scores and the generated distributed anomaly detection score to the RL model, wherein the RL model is operable to process the input feature tensor in accordance with its model parameters, and to select an amount which, if the sum of the obtained anomaly detection scores is reduced by that amount, is predicted to result in the distributed anomaly detection score falling below the threshold value. The representation of the obtained anomaly detection scores may comprise the generated input feature tensor from step 820a. The RL model is discussed in greater detail below with reference to example implementations of the methods disclosed herein.

Initiating a defensive action with respect to at least one of the incoming traffic flows may further comprise providing a defensive instruction to an administration node of the hierarchical system at step 840b. The defensive instruction may comprise the generated anomaly reduction action, and the administration node may be operable to select, from among the incoming traffic flows for which the obtained anomaly detection scores were generated, traffic flows for action (for example blocking) such that the sum of the obtained anomaly detection scores will reduce by the amount of the anomaly reduction action.

In step 850, regardless of whether or not the distributed anomaly detection score was above the threshold value, the detection node provides the distributed anomaly detection score to a detection node at a higher hierarchical level of the system. If the detection node is a QoS level detection node, the detection node may for example generate and provide the anomaly detection score to a Slice level detection node of the example implementation architecture discussed above. If the detection node is a Slice level detection node, the detection node may for example generate and provide the anomaly detection score to a Cluster level detection node of the example implementation architecture discussed above, for forwarding to a local level detection node. If the detection node is a local level detection node, the detection node may for example generate and provide the anomaly detection score to a regional level detection node of the example implementation architecture discussed above. If the detection node is a regional level detection node, the detection node may for example generate and provide the anomaly detection score to a cloud level detection node of the example implementation architecture discussed above. If the detection node is a cloud level detection node, step 850 may be omitted, as this is the highest level of the example implementation architecture.

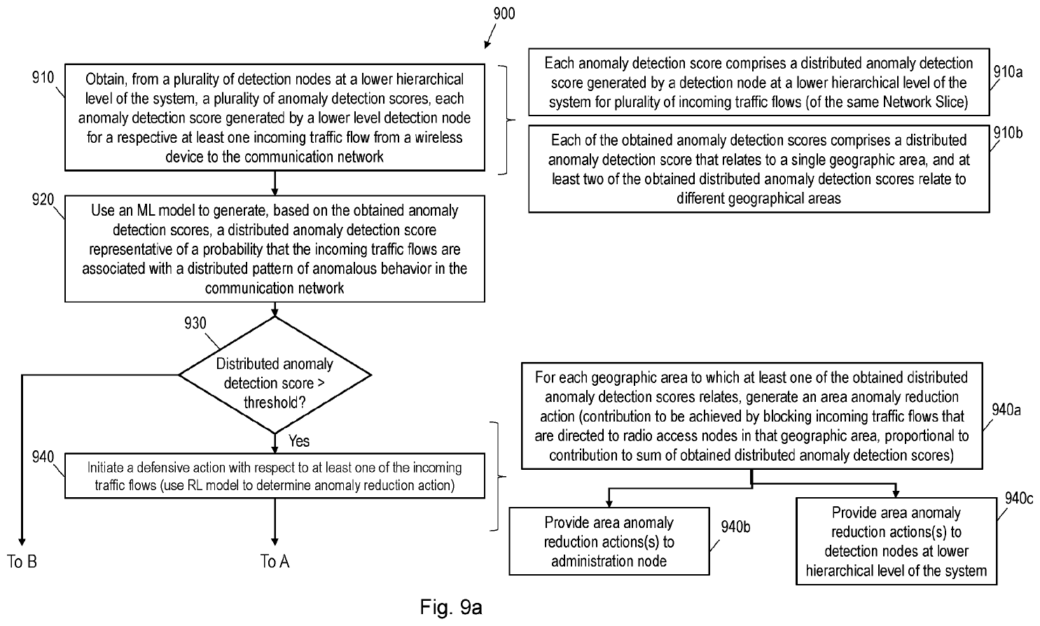

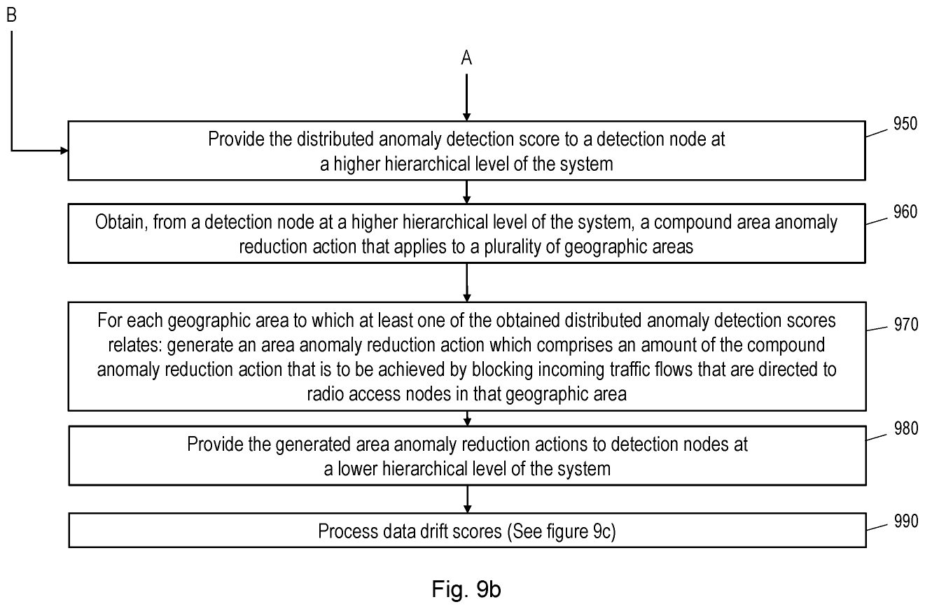

FIGS. 9a and 9b show flow charts illustrating process steps in another example of computer implemented method 900 for facilitating detection of anomalous behaviour in an edge communication network. The method 900 provides various examples of how the steps of the method 700 may be implemented and supplemented to achieve the above discussed and additional functionality, with particular reference to the functionality of higher level detection nodes. As for the method 700, the method 900 is performed by a detection node that is a component of a hierarchical system of detection nodes deployed in the edge communication network. As discussed above with reference to the method 400, the detection node performing the method 900 may comprise a physical or virtual node, and may be implemented in a computer system, computing device or server apparatus and/or in a virtualized environment, for example in a cloud, edge cloud or fog deployment. The detection node may for example be implemented in a core network of the communication network, and may be implemented in the Operation Support System (OSS), Orchestration And Management (OAM) system or in a Service Management and Orchestration (SMO) system. In other examples, the detection node may be implemented in a Radio Access node, which itself may comprise a physical node and/or a virtualized network function that is operable to exchange wireless signals. The detection node may be implemented as a function in an Open Radio Access Network (ORAN) or Virtualised Radio Access Network (vRAN). The detection node may encompass multiple logical entities and may for example comprise a Virtualised Network Function (VNF).

With reference to the example implementation architecture of FIG. 3, the detection node performing the method 900 may comprise a local level detection node, a regional level detection node and/or a cloud level detection node. It will be appreciated that the additional detail set out in the method 900 is a complement to, rather than an alternative to, the detail of the method 800. While the method 800 may be carried out by detection nodes at all hierarchical levels above the lowest level (flow level in the example architecture), the method 900 illustrates steps that may additionally be carried out by detection nodes at higher hierarchical levels that are above the first two hierarchical levels of the system (slice, local, regional and cloud levels in the example architecture).

Referring initially to FIG. 9a, in a first step 910, the detection node obtains, from a plurality of detection nodes at a lower hierarchical level of the system, a plurality of anomaly detection scores, each anomaly detection score generated by a lower level detection node for a respective at least one incoming traffic flow from a wireless device to the communication network. As illustrated at 910a, in the present example, each of the obtained anomaly detection scores comprises a distributed anomaly detection score generated by a detection node at a lower hierarchical level of the system for plurality of incoming traffic flows, and all of the pluralities of incoming traffic flows for which the obtained distributed anomaly detection scores were generated by the lower level nodes may belong to the same network slice.

As illustrated at 910b, according to the method 900, the edge communication network comprises a plurality of geographic areas, each area comprising a plurality of radio access nodes, and each of the obtained anomaly detection scores comprises a distributed anomaly detection score that relates to a single geographic area. At least two of the distributed anomaly detection scores obtained at step 910 relate to different geographical areas. With reference to the example implementation architecture of FIG. 3, the geographic area may be a cluster, local area, regional area or group of regional areas, depending on the level of the node. Thus, for a regional level detection node carrying out the method 900, each of the obtained anomaly detection scores comprises a distributed anomaly detection score that relates to a single local area within that region. Multiple obtained distributed anomaly detection scores may relate to the same local area, for example applying to different clusters within the same local area, but at least two of the obtained distributed anomaly detection scores relate to different local areas. For the purpose of the present disclosure, a distributed anomaly detection score that relates to a particular geographical area comprises a distributed anomaly detection score generated by a detection node at a lower hierarchical level of the system for a plurality of incoming traffic flows that are directed to radio access nodes within that geographical area.

In step 920, the detection node uses an ML model to generate, based on the obtained anomaly detection scores, a distributed anomaly detection score representative of a probability that the incoming traffic flows are associated with a distributed pattern of anomalous behaviour in the communication network. Reference is made to steps 820a, 820b and the accompanying discussion above for further detail of how the step 920 may be carried out (for example through generation of an input tensor etc.). In step 930, the detection node checks whether or not the generated distributed anomaly detection score is above a threshold value. If the distributed anomaly detection score is above a threshold value, the detection node initiates a defensive action with respect to at least one of the incoming traffic flows in step 940. As illustrated at step 940, this comprises using an RL model to determine an anomaly reduction action, based on the obtained anomaly detection scores and on the generated distributed anomaly detection score, wherein the anomaly reduction action comprises a reduction in the sum of the obtained anomaly detection scores that is predicted to cause the distributed anomaly detection score to fall below the threshold value. Again, reference is made to the method 800, and specifically to steps 840a and 840b and their accompanying description above, for further detail of the step of using an RL model to generate an anomaly reduction action.

Referring still to FIG. 9a, in the example method 900, the determined anomaly reduction action comprises a compound anomaly reduction action that applies to all of the geographic areas to which the obtained distributed anomaly detection scores relate. As illustrated at 940a, initiating a defensive action with respect to at least one traffic flow further comprises, for each geographic area to which at least one of the obtained distributed anomaly detection scores relates, generating an area anomaly reduction action which comprises an amount of the compound anomaly reduction action that is to be achieved by defensive actions (such as blocking) with respect to incoming traffic flows that are directed to radio access nodes in that geographic area. Thus, for a slice detection node performing the method 900, the generated compound (slice) anomaly reduction action applies to all of the clusters to which the obtained distributed anomaly reduction scores relate. Step 940a therefore comprises generating individual cluster anomaly reduction actions that apply to each of the represented clusters, and together will implement the compound (slice) anomaly reduction action. Similarly, for a regional detection node performing the method 900, the generated compound (regional) anomaly reduction action applies to all of the local areas to which the obtained distributed anomaly reduction scores relate. Step 940a consequently comprises generating individual local area anomaly reduction actions that apply to each of the represented local areas, and together will implement the compound (regional) anomaly reduction action.

The area anomaly reduction actions set out the contribution to be achieved by a defensive action (such as blocking) with respect to incoming traffic flows that are directed to radio access nodes in that geographic area, wherein the contribution is proportional to the contribution made by anomaly detection scores from that area to the sum of the obtained distributed anomaly detection scores. As illustrated at 940a, generating an area anomaly reduction score may therefore comprise calculating an amount of the compound anomaly reduction score that is proportional to the contribution of obtained distributed anomaly detection scores relating to that geographical area to the total sum of obtained distributed anomaly detection scores. In some examples, this may be achieved by calculating the ratio of the sum of anomaly detection scores from the area to the total sum of obtained anomaly detection scores, and multiplying the compound anomaly reduction action by the ratio.

As discussed above with reference to the method 800, initiating a defensive action with respect to incoming traffic flows further comprises providing a defensive instruction. In examples of the method 900, the defensive instruction comprises the area anomaly reduction actions generated at step 940a, and may be provided directly to the administration node of the hierarchical system in step 940b, or to detection nodes at a lower hierarchical level of the system in step 940c. Such lower detection nodes may perform additional processing, discussed below with reference to steps 960 to 980, before forwarding the defensive instruction on to the administration node or to further lower level hierarchical nodes. As discussed above, the administration node is operable to select, for each area and from among the incoming traffic flows for which the obtained anomaly detection scores (for the relevant area) were generated, traffic flows for defensive actions such as blocking such that the sum of the obtained anomaly detection scores will reduce by the amount of the area anomaly reduction action.

Referring now to FIG. 9b, and whether or not the generated distributed anomaly detection score was above the threshold level, the detection node then provides the distributed anomaly detection score to a detection node at a higher hierarchical level of the system in step 950. If the detection node performing the method 900 is at the highest hierarchical level of the system, then step 950 may be omitted.

For detection nodes performing the method 900 that are not at the top hierarchical level of the system, the detection node may, at step 960, obtain from a detection node at a higher hierarchical level of the system a compound area anomaly reduction action that applies to a plurality of geographic areas. This may in some examples be an area anomaly reduction action generated by a higher level node that is also performing the method 900. For example, a regional level node may generate several local area anomaly reduction actions in step 940a of the method, and initiate action to block one or more flows by providing those local anomaly reduction actions to the relevant local area detection nodes in step 940c. Each local anomaly reduction action is itself a compound anomaly reduction action that applies to a plurality of clusters.

In step 970, for each geographic area to which at least one of the obtained distributed anomaly detection scores relates, the detection node performing the method 900 generates an area anomaly reduction action which comprises an amount of the compound anomaly reduction action that is to be achieved by a defensive action (such as blocking) with respect to incoming traffic flows that are directed to radio access nodes in that geographic area. This may be achieved substantially as described above with reference to step 940. The detection node then, at step 980, provides the generated area anomaly reduction actions to detection nodes at a lower hierarchical level of the system. The detection node thus effectively processes the obtained compound area anomaly reduction action as if it had generated the compound area anomaly reduction action itself instead of obtaining it from a higher level node. Continuing the example from above, a local area detection node performing the method 900 and receiving a local anomaly reduction action at step 960 may consequently process the local anomaly reduction action in the same manner as if the local area detection node had generated the local anomaly reduction action itself at step 940.

Step 990 of the method 900 refers to the processing of one or more data drift scores. It will be appreciated that the step 990 of processing the data drift scores may be performed in parallel with the anomaly detection carried out in the steps discussed above. Reference is made to the method 600, and generation and provision by one or more lower level hierarchical nodes of a data drift score. These data drift scores may be passed by the detection nodes at the different hierarchical levels of the system up to the level at which the data drift scores are to be analysed. This may for example be the highest level detection node. In such examples, step 990 may consequently comprise passing received data drift scores along to a node at the next hierarchical level or directly to a node at the level at which data drift analysis and management will be performed. For a detection node that is performing data drift analysis and management (cloud level node of the example architecture), step 990 may comprise the sub steps illustrated in FIG. 9c.

Referring now to FIG. 9c, at step 992, the detection node obtains, from a plurality of detection nodes at a lower hierarchical level of the system, a plurality of data drift scores. As discussed above with reference to the method 600, and illustrated at 992a, the obtained data drift scores are representative of evolution of a statistical distribution of samples of incoming data flows obtained by detection nodes at a lower hierarchical level of the system over a data drift window. In step 994, the detection node generates a system data drift score from the plurality of obtained data drift scores. In step 996, if the system data drift score is above a threshold value, the detection node triggers retraining of ML models in detection nodes of the system. In some examples, the detection node may use an ML model to generate the system data drift score, as discussed in greater detail below with reference to example implementations of the methods of the present disclosure. ML (including RL) models for detection nodes in the system may be retrained in the cloud and propagated to the relevant detection nodes in the system.

The methods 500, 600, 700, 800 and 900 may be complemented by methods 1000, 1100 performed by an administration node of the system.

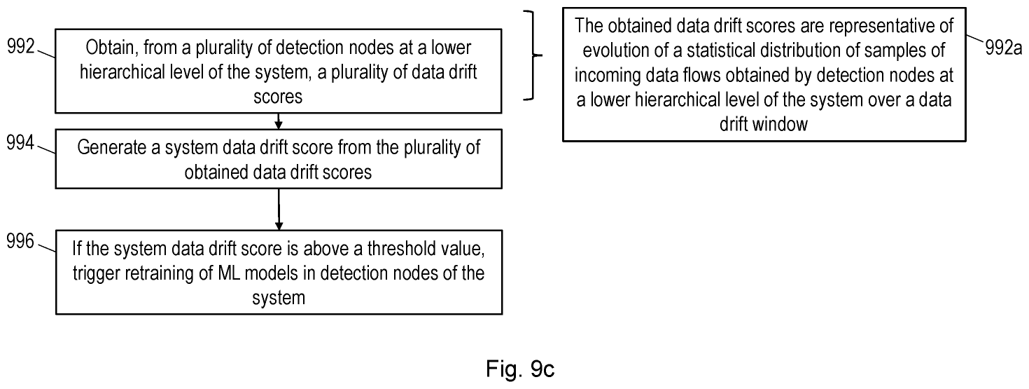

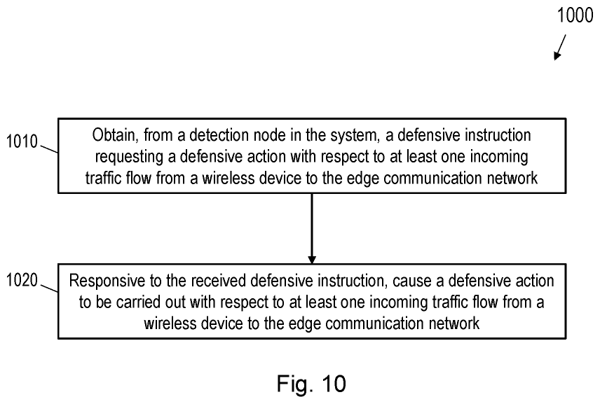

FIG. 10 is a flow chart illustrating process steps in a computer implemented method 1000 for facilitating detection of anomalous behaviour in an edge communication network. The method is performed by an administration node of a hierarchical system of detection nodes deployed in the edge communication network. The administration node performing the method 1000 may comprise a physical or virtual node, and may be implemented in a computer system, computing device or server apparatus and/or in a virtualized environment, for example in a cloud, edge cloud or fog deployment. The administration node may for example be implemented in a core network of the communication network, and may be implemented in the Operation Support System (OSS), Orchestration And Management (OAM) system or in a Service Management and Orchestration (SMO) system. In other examples, the administration node may be implemented in a Radio Access node, which itself may comprise a physical node and/or a virtualized network function that is operable to exchange wireless signals. The administration node may be implemented as a function in an Open Radio Access Network (ORAN) or Virtualised Radio Access Network (vRAN). The administration node may encompass multiple logical entities and may for example comprise a Virtualised Network Function (VNF).

Referring to FIG. 10, in a first step 1010, the method 1000 comprises obtaining from a detection node in the system a defensive instruction requesting a defensive action such as blocking of at least one incoming traffic flow from a wireless device to the edge communication network. In step 1020 the method 1000 further comprises, responsive to the received defensive instruction, causing a defensive action to be carried out with respect to at least one incoming traffic flow from a wireless device to the edge communication network. The defensive action may comprise causing the at least one incoming traffic flow to be blocked from accessing the edge communication network. The blocking may be temporary, for example for the duration of a blocking time window, as discussed in further detail below. In some examples, causing a defensive action to be carried out may comprise interacting with appropriate functional nodes in the communication network to initiate blocking, for example in the case of a 5G communication network, the administration node may interact with appropriate entities in the 5G SBA.

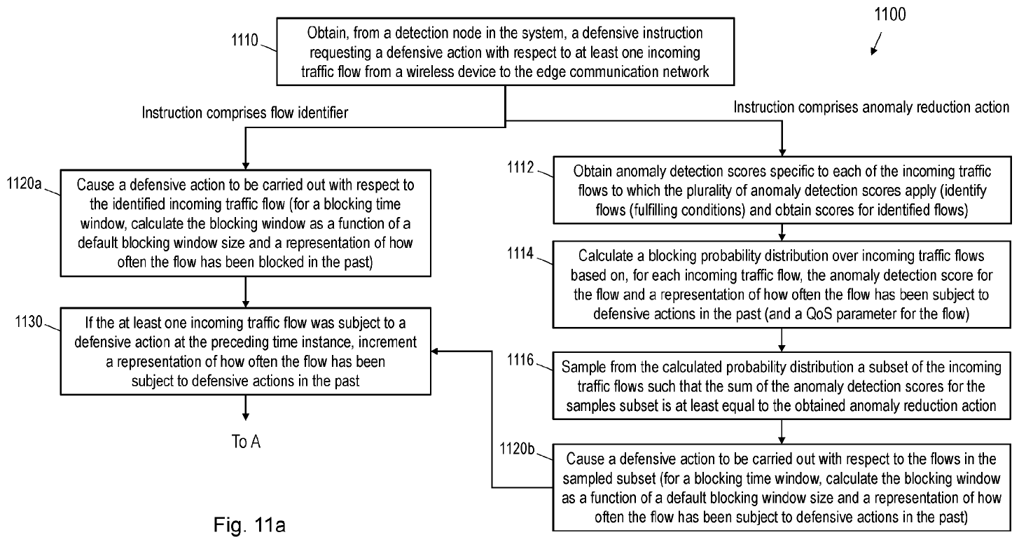

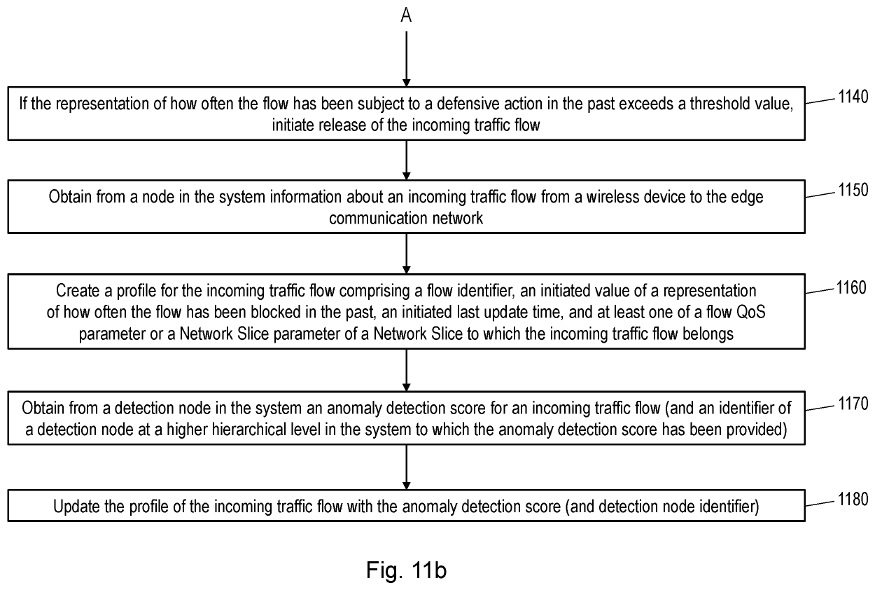

FIGS. 11a and 11b show flow charts illustrating process steps in another example of computer implemented method 1100 for facilitating detection of anomalous behaviour in an edge communication network. The method 1100 provides various examples of how the steps of the method 1000 may be implemented and supplemented to achieve the above discussed and additional functionality. As for the method 1000, the method 1100 is performed by an administration node of a hierarchical system of detection nodes deployed in the edge communication network. As discussed above with reference to the method 1000, the administration node performing the method 1100 may comprise a physical or virtual node, and may be implemented in a computer system, computing device or server apparatus and/or in a virtualized environment, for example in a cloud, edge cloud or fog deployment. The administration node may for example be implemented in a core network of the communication network, and may be implemented in the Operation Support System (OSS), Orchestration And Management (OAM) system or in a Service Management and Orchestration (SMO) system. In other examples, the administration node may be implemented in a Radio Access node, which itself may comprise a physical node and/or a virtualized network function that is operable to exchange wireless signals. The administration node may be implemented as a function in an Open Radio Access Network (ORAN) or Virtualised Radio Access Network (vRAN). The administration node may encompass multiple logical entities and may for example comprise a Virtualised Network Function (VNF).

Referring initially to FIG. 11a, in a first step 1110, the administration node obtains from a detection node in the system a defensive instruction requesting a defensive action with respect to at least one incoming traffic flow from a wireless device to the edge communication network. As illustrated in FIG. 11a, the defensive instruction may comprise one or more flow identifiers of the flow or flows to be subject to defensive actions, or may comprise one or more anomaly reduction actions.

If the defensive instruction received at step 1110 comprises an identifier of an incoming traffic flow, the administration node causes a defensive action to be carried out with respect to the identified incoming traffic flow. This may comprise causing the identified incoming traffic flow to be blocked from accessing the edge communication network in step 1120a. As illustrated, this may comprise causing the identified traffic flow to be blocked for a blocking time window, and step 1120a may further comprise calculating the blocking window for the at least one incoming traffic flow as a function of a default blocking window size and a representation of how often the flow has been blocked in the past.

Referring still to FIG. 11a, if the defensive instruction comprises an anomaly reduction action specifying a reduction in the sum of a plurality of anomaly detection scores, causing a defensive action to be carried out with respect to at least one incoming traffic flow from a wireless device to the edge communication network may comprise performing steps 1112 to 1120. In step 1112, the administration node obtains anomaly detection scores specific to each of the incoming traffic flows to which the plurality of anomaly detection scores apply. The incoming traffic flows to which the plurality of anomaly detection scores apply may comprise the plurality of traffic flows for which the plurality of anomaly detection scores were generated. In some examples, each of the plurality of anomaly detection scores may themselves be related to a plurality of flows, for example if the administration node receives a slice anomaly reduction action, or a cluster anomaly reduction action. Step 1112 may consequently allow the administration node to obtain the individual flow scores for the flows concerned. As illustrated at step 1112, obtaining anomaly detection scores specific to each of the incoming traffic flows to which the plurality of anomaly detection scores apply may first comprise identifying the incoming traffic flows to which the plurality of anomaly detection scores apply, before obtaining anomaly detection scores specific to the identified incoming traffic flows. Identifying the relevant incoming traffic flows may comprise identifying incoming traffic flows whose anomaly detection scores were reported to the detection node from which the defensive instruction was obtained, and which have a profile that was last updated within a time window that is specific to the hierarchical level at which the detection node resides in the system. Creation and updating of traffic flow profiles is discussed in greater detail below.

In step 1114, the administration node calculates a blocking probability distribution over the incoming traffic flows based on, for each incoming traffic flow, the anomaly detection score for the flow (obtained at step 1112) and a representation of how often the flow has been blocked in the past. The blocking probability distribution may also be calculated based on a QoS parameter associated with the flow. The QoS parameter may for example be a QoS priority, and other QoS and/or Network Slice parameters may also be included in the probability calculation.

In step 1116, the administration node samples from the calculated probability distribution a subset of the incoming traffic flows, such that the sum of the anomaly detection scores for the sampled subset is as close as possible to the obtained anomaly reduction action. In some examples, sampling at step 1116 may comprise sampling the smallest subset such that the sum of the anomaly detection scores for the sampled subset is as close as possible to the obtained anomaly reduction action.

In step 1120b, the administration node causes the flows in the sampled subset to be subject to defensive action such as being blocked from accessing the edge communication network. As discussed above with reference to step 1120a, this may comprise causing the identified traffic flow to be blocked for a blocking time window, and step 1120b may further comprise calculating the blocking window for the at least one incoming traffic flow as a function of a default blocking window size and a representation of how often the flow has been blocked in the past.

Following either step 1120a or 1120b, the administration node checks whether or not it caused the at least one incoming traffic flow to be subject to a defensive action at the preceding time instance and, if so, increments a representation of how often the flow has been subject to defensive actions in the past. If the same flow is not tagged for defensive action in the next detection process, the blocking factor will decrement (to a minimum value of 1).

Referring now to FIG. 11b, if the representation of how often the flow has been subject to defensive action in the past exceeds a threshold value, the administration node can take a more punitive defensive action such as initiating release of the incoming traffic flow at step 1140.

The administration node may, in addition to responding to received defensive instructions, generate and maintain profiles for incoming traffic flows, via steps 1150 to 1180. In step 1150, the administration node obtains, from a node in the system, information about an incoming traffic flow from a wireless device to the edge communication network. The node may comprise a dispatcher node, and the information may be received from the dispatcher node when this incoming flow is first received by the communication network. In step 1160, the administration node creates a profile for the incoming traffic flow comprising a flow identifier, an initiated value of a representation of how often the flow has been subject to defensive action in the past, an initiated last update time, and at least one of a Quality of Service parameter associated with the incoming traffic flow or/and a Network Slice parameter of a Network Slice to which the incoming traffic flow belongs. In step 1170, the administration node obtains from a detection node in the system, an anomaly detection score for an incoming traffic flow, and may also obtain, with the anomaly detection score, an identifier of a detection node at a higher hierarchical level in the system to which the anomaly detection score has been provided. In step 1180, the administration node updates the profile of the incoming traffic flow with the anomaly detection score and obtained detection node identifier. These updates may assist the administration node when carrying out for example step 1112 of the method at a later iteration. Flow profiles may be closed and/or deleted once a flow connection is closed.

In some examples, the administration node may additionally create and maintain UE profiles as well as flow profiles. A UE blocking factor may be maintained and incremented each time a traffic flow from a given UE is subject to a defensive action such as blocking for a period of time in a similar manner to the representation that is maintained for individual traffic flows. In this manner a UE may be blacklisted in the event that its UE blocking factor exceeds a threshold.

As discussed above, the methods 500 and 600 may be performed by a detection node, and the present disclosure provides a detection node that is adapted to perform any or all of the steps of the above discussed methods. The detection node may comprise a physical node such as a computing device, server etc., or may comprise a virtual node. A virtual node may comprise any logical entity, such as a Virtualized Network Function (VNF) which may itself be running in a cloud, edge cloud or fog deployment. The detection node may for example comprise or be instantiated in any part of a communication network node such as a logical core network node, network management center, network operations center, Radio Access node etc. Any such communication network node may itself be divided between several logical and/or physical functions, and any one or more parts of the management node may be instantiated in one or more logical or physical functions of a communication network node.

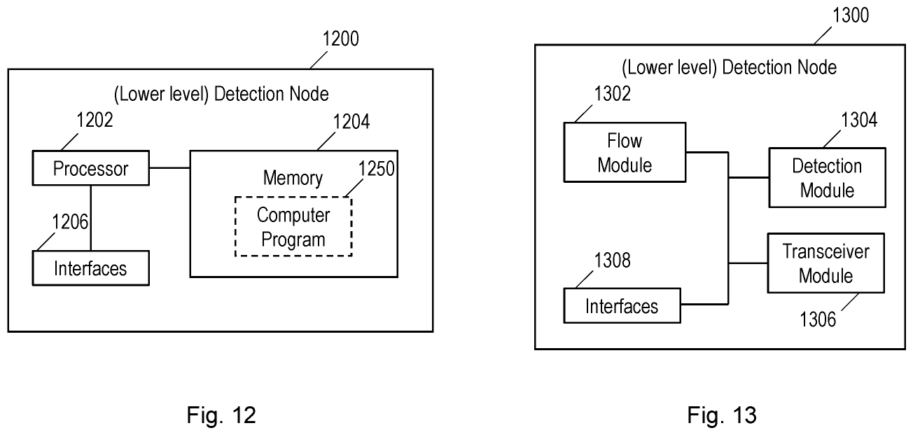

FIG. 12 is a block diagram illustrating an example detection node 1200 which may implement the method 500 and/or 600, as illustrated in FIGS. 5 to 6b, according to examples of the present disclosure, for example on receipt of suitable instructions from a computer program 1250. Referring to FIG. 12, the detection node 1200 comprises a processor or processing circuitry 1202, and may comprise a memory 1204 and interfaces 1206. The processing circuitry 1202 is operable to perform some or all of the steps of the method 500 and/or 600 as discussed above with reference to FIGS. 5 to 6b. The memory 1204 may contain instructions executable by the processing circuitry 1202 such that the detection node 1200 is operable to perform some or all of the steps of the method 500 and/or 600, as illustrated in FIGS. 5 to 6b. The instructions may also include instructions for executing one or more telecommunications and/or data communications protocols. The instructions may be stored in the form of the computer program 1250. In some examples, the processor or processing circuitry 1202 may include one or more microprocessors or microcontrollers, as well as other digital hardware, which may include digital signal processors (DSPs), special-purpose digital logic, etc. The processor or processing circuitry 1202 may be implemented by any type of integrated circuit, such as an Application Specific Integrated Circuit (ASIC), Field Programmable Gate Array (FPGA) etc. The memory 1204 may include one or several types of memory suitable for the processor, such as read-only memory (ROM), random-access memory, cache memory, flash memory devices, optical storage devices, solid state disk, hard disk drive etc.

FIG. 13 illustrates functional units in another example of detection node 1300 which may execute examples of the methods 500 and/or 600 of the present disclosure, for example according to computer readable instructions received from a computer program. It will be understood that the units illustrated in FIG. 13 are functional units, and may be realized in any appropriate combination of hardware and/or software. The units may comprise one or more processors and may be integrated to any degree.

Referring to FIG. 13, the detection node 1300 is for facilitating detection of anomalous behaviour in an edge communication network. The detection node 1300 is a component of a hierarchical system of detection nodes deployed in the edge communication network. The detection node 1300 comprises a flow module 1302 for obtaining samples of an incoming traffic flow from a wireless device to the communication network, and an anomaly module 1304 for using an ML model to generate, based on the received samples, an anomaly detection score representative of a probability that the incoming traffic flow is associated with anomalous behaviour in the communication network. The detection node 1300 further comprises a transceiver module 1306 for providing the anomaly detection score to a detection node at a higher hierarchical level of the system, and, if the anomaly detection score is above a threshold value, for initiating a defensive action with respect to the incoming traffic flow. The detection node 1300 may further comprise interfaces 1308 which may be operable to facilitate communication with other communication network nodes over suitable communication channels.

As discussed above, the methods 700, 800 and 900 may be performed by a detection node, and the present disclosure provides a detection node that is adapted to perform any or all of the steps of the above discussed methods. The detection node may comprise a physical node such as a computing device, server etc., or may comprise a virtual node. A virtual node may comprise any logical entity, such as a Virtualized Network Function (VNF) which may itself be running in a cloud, edge cloud or fog deployment. The detection node may for example comprise or be instantiated in any part of a communication network node such as a logical core network node, network management center, network operations center, Radio Access node etc. Any such communication network node may itself be divided between several logical and/or physical functions, and any one or more parts of the management node may be instantiated in one or more logical or physical functions of a communication network node.

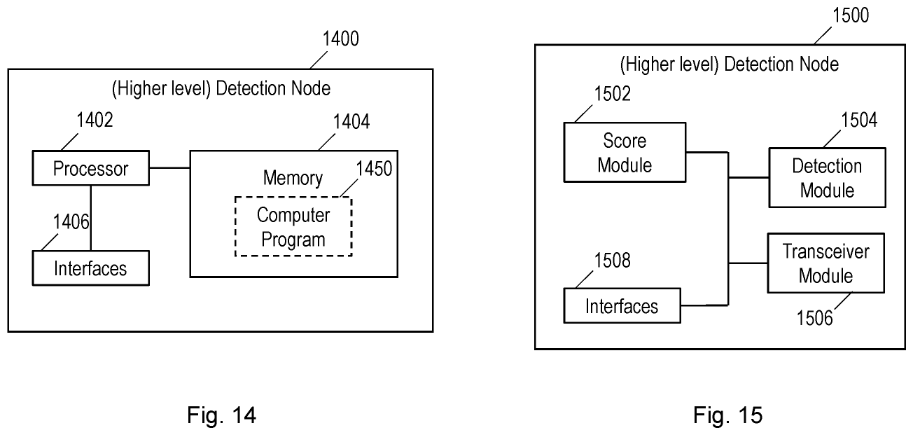

FIG. 14 is a block diagram illustrating an example detection node 1400 which may implement the method 700, 800 and/or 900, as illustrated in FIGS. 7 to 9c, according to examples of the present disclosure, for example on receipt of suitable instructions from a computer program 1450. Referring to FIG. 14, the detection node 1400 comprises a processor or processing circuitry 1402, and may comprise a memory 1404 and interfaces 1406. The processing circuitry 1402 is operable to perform some or all of the steps of the method 700, 800 and/or 900 as discussed above with reference to FIGS. 7 to 9c. The memory 1404 may contain instructions executable by the processing circuitry 1402 such that the detection node 1400 is operable to perform some or all of the steps of the method 700, 800 and/or 900, as illustrated in FIGS. 7 to 9c. The instructions may also include instructions for executing one or more telecommunications and/or data communications protocols. The instructions may be stored in the form of the computer program 1450. In some examples, the processor or processing circuitry 1402 may include one or more microprocessors or microcontrollers, as well as other digital hardware, which may include digital signal processors (DSPs), special-purpose digital logic, etc. The processor or processing circuitry 1402 may be implemented by any type of integrated circuit, such as an Application Specific Integrated Circuit (ASIC), Field Programmable Gate Array (FPGA) etc. The memory 1404 may include one or several types of memory suitable for the processor, such as read-only memory (ROM), random-access memory, cache memory, flash memory devices, optical storage devices, solid state disk, hard disk drive etc.

FIG. 15 illustrates functional units in another example of detection node 1500 which may execute examples of the methods 700, 800 and/or 900 of the present disclosure, for example according to computer readable instructions received from a computer program. It will be understood that the units illustrated in FIG. 15 are functional units, and may be realized in any appropriate combination of hardware and/or software. The units may comprise one or more processors and may be integrated to any degree.

Referring to FIG. 15, the detection node 1500 is for facilitating detection of anomalous behaviour in an edge communication network. The detection node 1500 is a component of a hierarchical system of detection nodes deployed in the edge communication network. The detection node 1500 comprises a score module 1502 for obtaining, from a plurality of detection nodes at a lower hierarchical level of the system, a plurality of anomaly detection scores, each anomaly detection score generated by a lower level detection node for a respective at least one incoming traffic flow from a wireless device to the communication network. The detection node further comprises a detection module 1504 for using an ML model to generate, based on the obtained anomaly detection scores, a distributed anomaly detection score representative of a probability that the incoming traffic flows are associated with a distributed pattern of anomalous behaviour in the communication network. The detection node 1500 further comprises a transceiver module 1506 for, if the distributed anomaly detection score is above a threshold value, initiating a defensive action with respect to at least one of the incoming traffic flows. The detection node 1500 may further comprise interfaces 1508 which may be operable to facilitate communication with other communication network nodes over suitable communication channels.

As discussed above, the methods 1000 and 1100 may be performed by an administration node, and the present disclosure provides an administration node that is adapted to perform any or all of the steps of the above discussed methods. The administration node may comprise a physical node such as a computing device, server etc., or may comprise a virtual node. A virtual node may comprise any logical entity, such as a Virtualized Network Function (VNF) which may itself be running in a cloud, edge cloud or fog deployment. The administration node may for example comprise or be instantiated in any part of a communication network node such as a logical core network node, network management center, network operations center, Radio Access node etc. Any such communication network node may itself be divided between several logical and/or physical functions, and any one or more parts of the management node may be instantiated in one or more logical or physical functions of a communication network node.

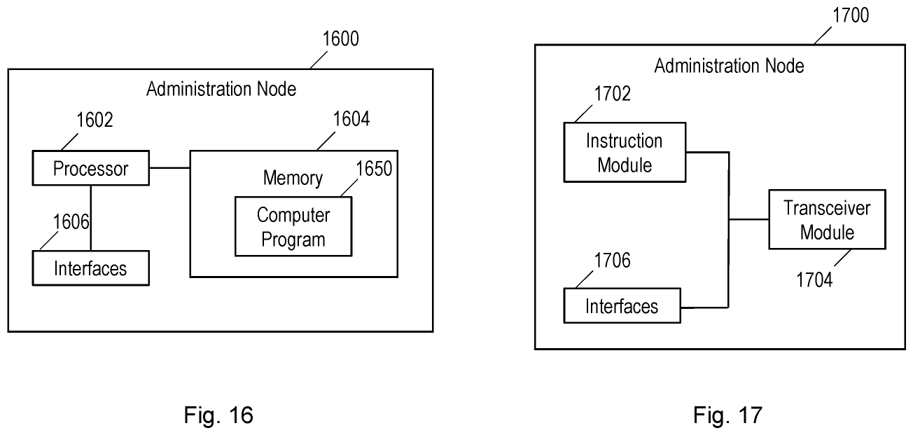

FIG. 16 is a block diagram illustrating an example administration node 1600 which may implement the method 1000 and/or 1100, as illustrated in FIGS. 10 to 11b, according to examples of the present disclosure, for example on receipt of suitable instructions from a computer program 1650. Referring to FIG. 16, the administration node 1600 comprises a processor or processing circuitry 1602, and may comprise a memory 1604 and interfaces 1606. The processing circuitry 1602 is operable to perform some or all of the steps of the method 1000 and/or 1100 as discussed above with reference to FIGS. 10 to 11b. The memory 1604 may contain instructions executable by the processing circuitry 1602 such that the administration node 1600 is operable to perform some or all of the steps of the method 1000 and/or 1100, as illustrated in FIGS. 10 to 11b. The instructions may also include instructions for executing one or more telecommunications and/or data communications protocols. The instructions may be stored in the form of the computer program 1650. In some examples, the processor or processing circuitry 1602 may include one or more microprocessors or microcontrollers, as well as other digital hardware, which may include digital signal processors (DSPs), special-purpose digital logic, etc. The processor or processing circuitry 1602 may be implemented by any type of integrated circuit, such as an Application Specific Integrated Circuit (ASIC), Field Programmable Gate Array (FPGA) etc. The memory 1604 may include one or several types of memory suitable for the processor, such as read-only memory (ROM), random-access memory, cache memory, flash memory devices, optical storage devices, solid state disk, hard disk drive etc.

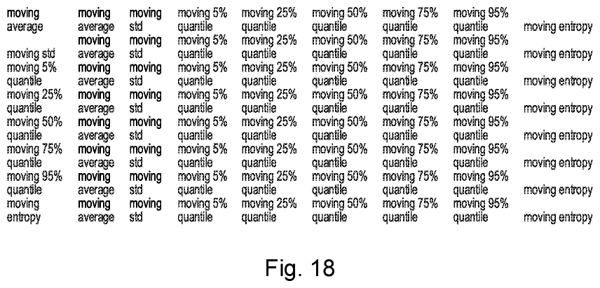

FIG. 17 illustrates functional units in another example of administration node 1700 which may execute examples of the methods 1000 and/or 1100 of the present disclosure, for example according to computer readable instructions received from a computer program. It will be understood that the units illustrated in FIG. 17 are functional units, and may be realized in any appropriate combination of hardware and/or software. The units may comprise one or more processors and may be integrated to any degree.

Referring to FIG. 17, the administration node 1700 is for facilitating detection of anomalous behaviour in an edge communication network. The administration node is a component of a hierarchical system of detection nodes deployed in the edge communication network. The administration node 1700 comprises an instruction module 1702 for obtaining from a detection node in the system defensive instruction requesting a defensive action with respect to at least one incoming traffic flow from a wireless device to the edge communication network. The administration node 1700 further comprises a transceiver module 1704 for, responsive to the received defensive instruction, causing a defensive action to be carried out with respect to at least one incoming traffic flow from a wireless device to the edge communication network to be system. This may comprise causing the identified incoming traffic flow to be blocked from accessing the edge communication network. The administration node 1700 may further comprise interfaces 1706 which may be operable to facilitate communication with other communication network nodes over suitable communication channels.

FIGS. 4 to 11b discussed above provide an overview of methods which may be performed according to different examples of the present disclosure. These methods may be performed by different examples of detection node and administration node, as illustrated in FIGS. 12 to 17. There now follows a detailed discussion of functionality that may be present in such nodes, and of how different process steps illustrated in FIGS. 4 to 11b and discussed above may be implemented. Much of the following discussion makes reference to the example implementation architecture of FIG. 3, and the hierarchical levels of flow, QoS, Slice, Cluster, Local, Regional and Cloud. It will be appreciated however that this is merely for the purposes of explanation, and the implementation and functional detail discussed below is equally applicable to other implementation architectures for the present disclosure, which may comprise a greater or smaller number of hierarchical layers, and whose layers may be differently defined.

### Functional Modules of Detection Nodes

Several functional modules may be present in different examples of detection nodes performing methods as set out above. The following discussion covers three possible functional modules.

### 1. Data Collection/Cleaning and Feature Extraction Module (DCCFEM):

Each detection node at the different hierarchical levels of the system may comprise a data collection/cleaning and feature extraction module. This module is responsible for collecting and cleaning data, and then extracting features from the data. These features may include average, standard deviation, minimum, maximum, sum, median, skewness, kurtosis, 5%, 25%, 75%, 95% quantiles, entropy, etc. Lower level (for example flow level) DCCFEMs will process and extract features from the number of packets and their payload size received each X milliseconds from a given data traffic flow. The value of X may be configurable according to the requirements of a particular deployment. It may be envisaged to extract dozens of features from timeseries data obtained by the detection nodes, but it will be appreciated that this could result in longer processing times, which could in turn cause delays, particularly at the start of the process if many features are extracted from individual flow data.

### 2. Data Drift Detection Module:

Each lower level (for example flow level) detection node may comprise a data drift detection module. This module compares changes in distribution of the incoming traffic each “data drift window” of N time units (hours for example). The value of N may be configurable according to the requirements of a particular deployment. Examples of the present disclosure use changes in timeseries features such as average, standard deviation, minimum, maximum, sum, median, 5%, 25%, 75%, 95% quantiles, entropy, etc. of the flow features, as extracted by the DCCFEM. These statistics are referred to hereafter as “data drift features”. For a given metric, such as packet size, each data drift window (of configurable length), a subset of the incoming traffic flows received in the same slice and having the same or similar QoS features will be randomly selected. If similar QoS features are used, similarity may be established via clustering or any other suitable method. For each selected incoming flow, a set of features is generated from a plurality of samples of that incoming flow. Using features extracted from these incoming flows as inputs, additional features could be generated to represent the statistical distribution of incoming data flows received by the node during the considered window of time. These additional features are referred to as data distribution features, and may be assembled in a data distribution features matrix as discussed below.

In one example, during a time window of N time units a flow level node Is considered to have calculated Z data drift feature vectors. As each data drift feature vector is a vector of average, standard deviation, minimum, maximum, sum, median, 5%, 25%, 75%, 95% quantiles, entropy, etc., so calculating an average over all the “average” feature will result in an average of averages. Similarly, calculating std over the “average” feature will result in std of averages, and so on. The end result will resemble:
Average: [average of average features, std of the average features, etc.]
Std: [average of the std features, std of the std features, etc.]
. . .

The end result features can be assembled into a data distribution features matrix. At the end of the data drift time window, which may be configurable, predefined, random, etc., another data distribution features matrix will be generated.

Calculating the difference between the two data distribution features matrices results in a data drift features change matrix for the considered metric (packet size for example), an example extract of which is illustrated in FIG. 18. When considering features of traffic flows, a separate matrix may be generated for packet number, payload size, etc.

Following additional processing if appropriate (including for example scaling), the generated data drift features change matrices can be used as input to an ML process for generating a data drift score, or a weighted mean or other operation may be used to generate a data drift score.

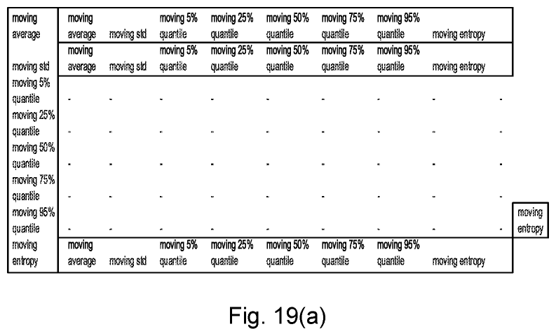

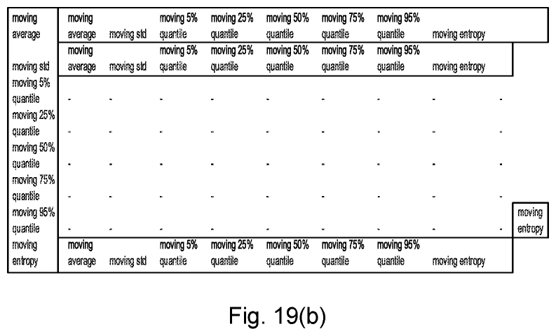

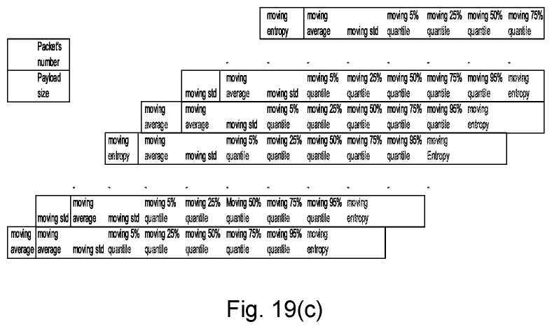

In a first example, an ML model can be trained to receive as input a tensor built using data drift features change matrices, and to produce as output a score of “data drift change”, which provides a representation of the extent to which the statistical distribution of the incoming data has evolved, and consequently the need for retraining of ML models used to identify anomalous behaviour in the incoming data. The data drift features change matrices may be subject to further processing such as scaling for example, before being used to generate an input to an ML model such as a convolution Neural Network, as illustrated in FIG. 19.

FIG. 19 illustrates an example data drift feature change tensor. The tensor has dimensions:

(height×width×channels)=(1×number of features×(2×number of features)) (1)

Considering part c of FIG. 19, which represents the final tensor, the first channel is the “data drift features change” vector of the “average” of the number of packets for individual flows, and the second channel is the “data drift features change” of the “std” of the number of packets for individual flows. The channels continue until the final channel of “data drift features change” vector of the “entropy” of packet payload size for “individual flows”.

The final multi-dimensional tensor will be the input to an ML model such as a Convolution Neural Network (CNN), which is referred to as a “data drift change CNN”, and which provides as output a value between [0,1] that corresponds to “data drift change score”. The depth, pooling, kernel size, stride, learning rate, and activation functions (such as LeakyReLU, ReLu, Sigmoid, etc.) of the CNN are subject to experimentation to define their optimal values. In some examples, if a different ML model is preferred, the drift features change matrices can be reshaped to suit the preferred ML model type.

If processing resources are limited, it is possible to simply flatten the data drift features change tensor and use a multi-layered perceptron for example (or another type of ML model if preferred), with an input layer of the same size as the tensor, N hidden layers, and one output neuron to output one value between [0,1].

As discussed above, in a second example, training such a model may be prohibitively difficult or expensive, for example owing to labelled data unavailability. In such cases, the data drift features matrices may (after further processing such as scaling for example if appropriate) be multiplied by weight matrices to obtain “weighted data drift features change matrices”. The weighted mean value for the resulting matrices may then be considered as the “data drift change score”. After generating the data drift change score, the node may provide this score, along with the corresponding network slice features and QoS features, to a suitable higher level node.

### 3. Anomaly Detection Module (ADM):

Each detection node at the different hierarchical levels of the system may comprise an ADM. The ADM may comprise, for example, a trained ML model based on supervised algorithms for classification such as XGboost, RandomForest, etc., or Deep learning based models based on CNN, LSTM, Transformers, etc. The model will receive features extracted by a DCCFEM module and other features (depending on the node) and will output an anomaly detection score indicating a likelihood that the input features represent anomalous behaviour.

### Example Implementation Architecture

As illustrated in FIG. 3, example methods according to the present disclosure may be implemented in a system comprising multiple detection nodes at different hierarchical levels. In one example, the different detection nodes may include the following:

### 1. Data Sampling Node

This node samples from a UE's traffic flow with a predefined frequency.

### 2. Data Dispatcher Node

This node guarantees forwarding of an incoming traffic flow to an available flow level node.

### 3. Flow Level Detection Node:

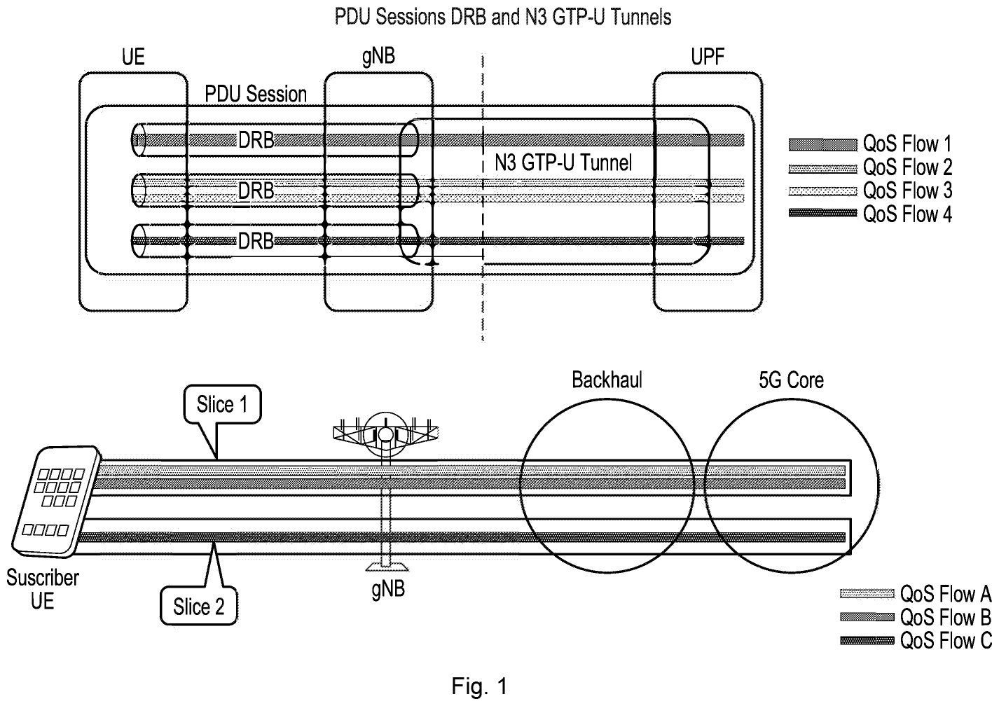

For a specific slice in an area (referred to as a cluster), UE traffic flow may be identified in a manner selected for a given deployment and/or use case. For example, a UE traffic flow may be identified by a PDU session identifier and QoS flow identifier (as illustrated for example in FIG. 1). Identification at this level of abstraction is referred to as “flow level”. Flow level detection nodes detect anomalies associated with attack attempts on the flow level. This node comprises:
A DCCFEM
A data drift detection mechanism
An anomaly detection model (ADM), referred to as a “flow level ADM”, which receives as input features extracted by the node's DCCFEM from incoming traffic on the flow level.

### 4. QoS Level Detection Node:

This node detects attack attempts on a QoS level based on flow level anomaly detection scores received from flow level nodes of a given slice for a specific cluster's node. This node comprises:
A DCCFEM
A module for processing data drift scores.
An ADM, referred to as a “QoS level ADM” that receives as input: the output of flow level nodes, QoS features (such as priority level, Packet delay Budget, etc.), and Network slice features (extracted from Service Level Agreement “SLA”, such as performance, availability, etc.).
An RL module (based on Deep Deterministic Policy Gradient (DDPG), Proximal Policy Optimisation (PPO), Advantage Actor Critic (A2C), or Soft actor-critic, etc. algorithms) that selects an amount by which the sum of the received anomaly detection scores must reduce, so as to hamper a detected attempt at a distributed attack such as a Distributed Denial of Service Attack (DDoS) attack.

### 5. Slice Level Detection Node:

Each slice has a Slice level node that helps in detecting anomalies (possible attacks) for all flows that belong to the same slice in a specific cluster. The slice level detection node comprises:
A DCCFEM
An ADM, referred to as “Slice level ADM”, which receives as input: the output of QoS level node(s), the QoS features (such as priority level, Packet delay Budget, etc.), and the slice's features.
An RL module (based on Deep Deterministic Policy Gradient (DDPG), Proximal Policy Optimisation (PPO), Advantage Actor Critic (A2C), or Soft actor-critic, etc. algorithms) that selects an amount by which the sum of the received anomaly detection scores must reduce, so as to hamper a detected attempt at a distributed attack such as DDoS attack.

### 6. Cluster Level Node:

As slice isolation should be enforced, and each slice's performance (security, QoE, etc.) should not have impact on the performance of other slices, this node is used to process outputs of Slice nodes of the same cluster. This node comprises:
A DCCFEM
An ADM “Cluster level ADM” which receives the output of the Slice level nodes of the same cluster

### 7. Flow Administration Node:

This node manages incoming flows based on outputs from Flow, QoS, Slice, Local, Regional and/or Cloud level nodes. The flow administration node may be implemented as a distributed system or on the Core network level or cloud level for example.

### 8. Local Level Detection Node:

Sited at a local office, this node communicates with cluster nodes in its local area. The local detection node comprises:
A DCCFEM
An ADM, referred to as a “Local level ADM”, which receives the output of Cluster nodes in its local area
An RL module (based Deep Deterministic Policy Gradient (DDPG), Proximal Policy Optimisation (PPO), Advantage Actor Critic (A2C), Soft actor-critic, etc. algorithms) that selects an amount by which the sum of the received anomaly detection scores must reduce, so as to hamper a detected attempt at a distributed attack such as a Distributed Denial of Service (DDoS) attack.

### 9. Regional Level Detection Node:

Sited at a regional office, this node communicates with local nodes in its regional area. The regional node comprises:
A DCCFEM
An ADM, referred to as a “Regional level ADM” which receives the output of the local level nodes in its regional area
An RL module (based for example on Soft Actor-Critic or DDPG or PPO or A2C . . . algorithms) that helps in the selection of the number of “flow level” to be subject to defensive actions such as blocking, in order to hamper an attempt of Distributed attack such as DDoS attacks.

### 10. Cloud Level Detection Node:

This node communicates with regional nodes. The cloud level detection node comprises:
A DCCFEM
An ADM, referred to as a “Cloud level ADM” which receives the output of the Regional nodes
An RL module (based for example on Soft Actor-Critic or DDPG or PPO or A2C . . . algorithms) that helps in the selection of the number of “flow level” to be subject to defensive actions such as blocking, in order to hamper an attempt of Distributed attack such as DDoS attacks.
The cloud level node may also have a module for processing data drift scores and determining whether retraining of ML models at the various detection modules is appropriate.

### Example Process Flow

In order to ensure communication between nodes, in one example implementation, the system may use the event-streaming system called apache Kafka, which is a distributed, highly scalable, elastic, fault-tolerant, and secure system which can be run as a cluster of one or more servers that can span multiple datacentres or cloud regions. Kafka uses a publish-subscribe protocol, such that if a set of nodes are to send messages to a higher level node, this is achieved by creating a topic that represents the category of messages sent by those nodes (which are considered as producers). The higher level node (considered as consumer) can read those messages. The methods 400 to 1100 refer to the providing and obtaining of information. In the following example process flow implementation these methods, reference is made to sending and receiving of messages, for example by node A to node B, as an example implementation of provision and obtaining of data. However, it will be appreciated that if implemented in Kafka, the provision and obtaining of information would be implemented as node A publishing (write) an event (message), and node B consuming that event.

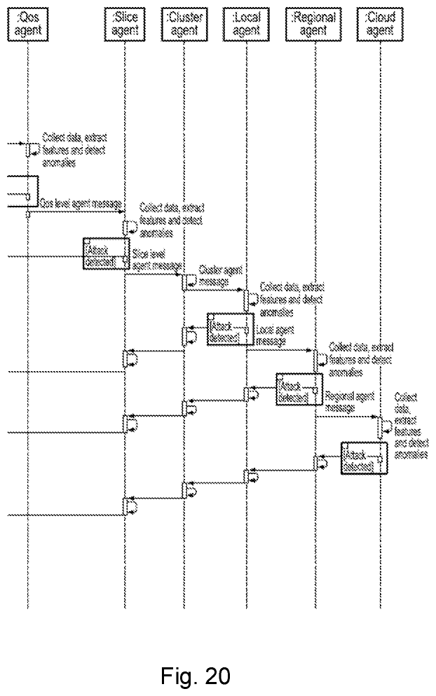

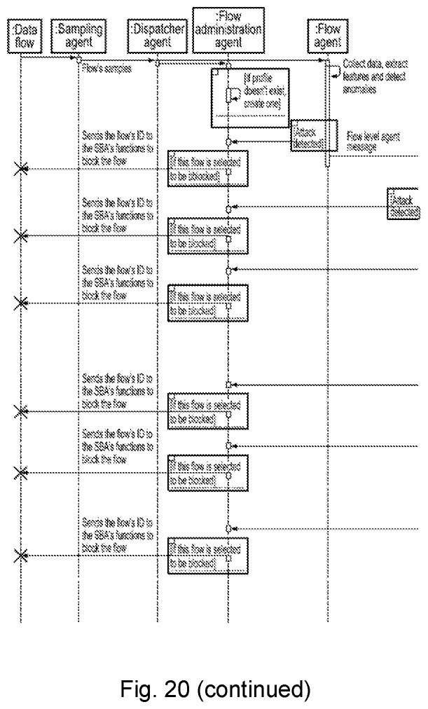

FIG. 20 is a sequence diagram for an implementation of methods according to the present disclosure in a system for attack detection and prevention. Referring to FIG. 20, for an incoming traffic flow from a UE, the flow identified by a “flow identifier”, with known Slice and QoS features (such as Priority level, Packet delay budget, packet error rate averaging window, etc.):
1. At initial connection, the incoming flow is forwarded to the targeted Data network to ensure low latency.
2. At the same time, the sampling node has access to the incoming flow (packets processed by the UPF), to be able to sample from it (samples identified by flow identifier) and then forward samples to the dispatcher node, which in its turn forwards the samples to an available flow level detection node, and forwards information about the flow to the flow administration node:
   2.1. “Flow Administration Node”:
      2.1.1. At the beginning of each incoming flow, this node will receive the flow information such the flow identifier in order to create a profile. The profile also contains Slice and QoS features (from NSSF and PCF, etc.) a “last update time” timestamp and a Blocking factor initiated to 1.
      2.1.2. This profile will be deleted once the corresponding flow's connection is closed. The Blocking factor will be used to help calculating the window of time for which the incoming flow will be blocked in case of detection of anomalous behaviour indicating an attempt at an attack (explained in the following steps).
   2.2. Available flow level node. The flow level node:
      2.2.1. Extracts features from the incoming flow samples. For instance, for each X time units, it calculates the mean, sum, std, min, max, median, quantiles 5%, 25%, 75%, 95% and entropy, of the incoming flow's packet numbers and payload size, for example. Along with QoS features and slice features, the extracted features form the “Flow ADM input tensor”.
      2.2.2. Using the flow level ADM model which receives as input “Flow ADM input tensor”, detects if there is an anomaly indicating an attempt at an attack, and outputs a score “anomaly detection score” (also referred to as flow score).
      2.2.3. If the score corresponds to a possible anomaly (above a threshold value), sends an alert (defensive instruction) with the flow identifier to “Flow administration node”,
      2.2.4. On receiving such alert, the Flow administration node will, using the flow identifier, communicate with the SBA functions to take defensive actions such as temporarily blocking that flow for “block window” time units. The block window size is calculated as follow:

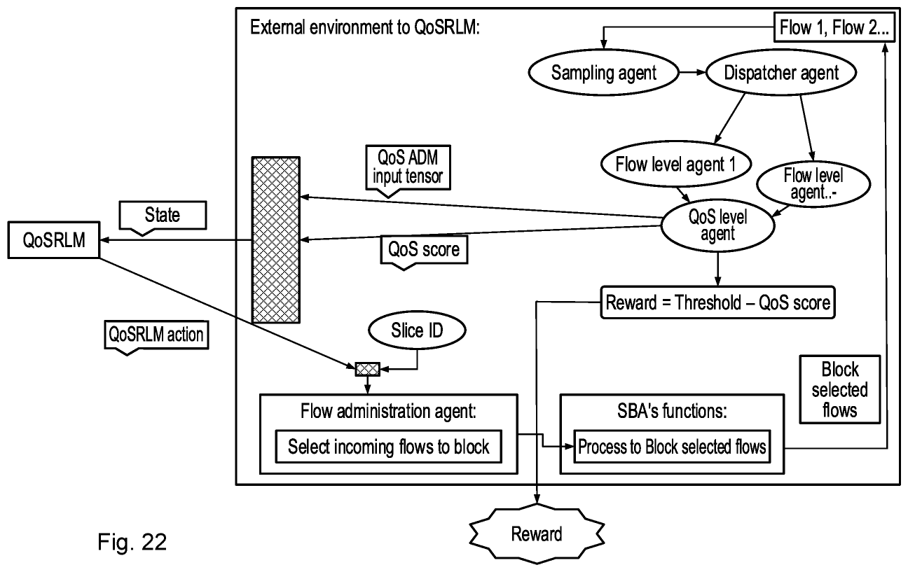

block window =flow's blocking factor×(block window default size) (2)
2.2.5. If the same flow is tagged as anomalous (possible attempted attack) in any future detection process, the blocking factor will increment by 1. If the same flow is not tagged in the next detection process, the blocking factor will decrement (to a minimum value of 1).
2.2.6. If the blocking factor reaches a predefined threshold: “close threshold”, the Flow administration node can take more punitive defensive actions such as initiating a process to close (release) the corresponding flow (through communication with appropriate SBA functions in a 5G use case).
2.2.7. It is also possible (for example through communication with SBA Virtual Network functions such as the AMF) to black-list the corresponding UE, if its flows have been released more than a predefined threshold “UE blacklist threshold” number of times within a predefined interval of time. Such functionality assumes creation of a profile for each UE with the corresponding gauge.
2.2.8. If no attack attempt has been detected, the flow will not be blocked.
2.2.9. Regardless of whether the flow level node has detected an attack attempt or not, it:
2.2.10. Sends the generated score (anomaly detection score) to its QoS level node.
2.2.11. Sends the same score along with the flow identifier to the “Flow administration node”, as well as the node identifier of the QoS level detection node to which the anomaly detection scores have been sent. This allows the administration node to update the corresponding flow's profile.
3. During each “QoS waiting window” of a predefined number of time units, the QoS level detection node:
   3.1. Using the received anomaly detection scores, extracts features using the DCCFEM.
   3.2. Using the extracted features from the previous step, the QoS features and the slice features, generates the “QoS ADM input tensor” then passes it to the QoS level ADM to detect if there is an anomaly indicating a possible attempt of attack, and outputs a score “anomaly detection score”, also referred to as “QoS score”.
   3.3. If the score corresponds to a possible attempted attack (above a threshold value), QoS level node sends an alert (defensive instruction), to “Flow administration node”, to take defensive action such as blocking X flows (for example the X flows with highest flow level scores).
      These X flows are selected as follows:
3.3.1. Using a trained Reinforcement Learning model (QoSRLM, trained as illustrated in FIG. 22 discussed below), which receives as input the QoS ADM input tensor and the QoS score, and outputs a real number “QoSRLM action” which corresponds to an amount by which the sum of the received flow scores should be reduced in order to reduce the generated “QoS score” below a “QoS attack attempt” threshold. The reward of the RL model is given by:

Reward=QoS attack attempt threshold−new QoS score after blocking selected flows (3)
3.4. The QoS level detection node sends “QosRLM action”, along with information such as slice ID, QoS ID and QoS level node ID to the “Flow administration node”. In its turn, the “Flow administration node”:
   3.4.1. Based on the output of QoSRLM, selects the X flows of the corresponding slice ID and QoS ID to be subject of defensive actions such as blocking based on their flow's score and their QoS features. These are user flows processed by flow level nodes reported to this QoS level node and with a “last update time” within the last “QoS waiting window” time units. In the following example, the QoS feature “Priority level” is included in calculating the block probability, however, additional or alternative features could also be considered. To avoid excessive blocking of the same flow, a “block probability” may be used to make the selection stochastic, where block probability is equal to:

$$block probability for flow ( i ) = \frac{( \frac{flow {( i )}^{′} s blocking factor \times flow {( i )}^{′} score}{flow {( i )}^{′} {sQoS}^{′} priority} )}{{\sum }_{j = 1}^{X} ( \frac{flow {( j )}^{′} s blocking factor \times flow {( j )}^{′} s score}{flow {( j )}^{′} {sQoS}^{′} priority} )} \qquad ( 4 )$$

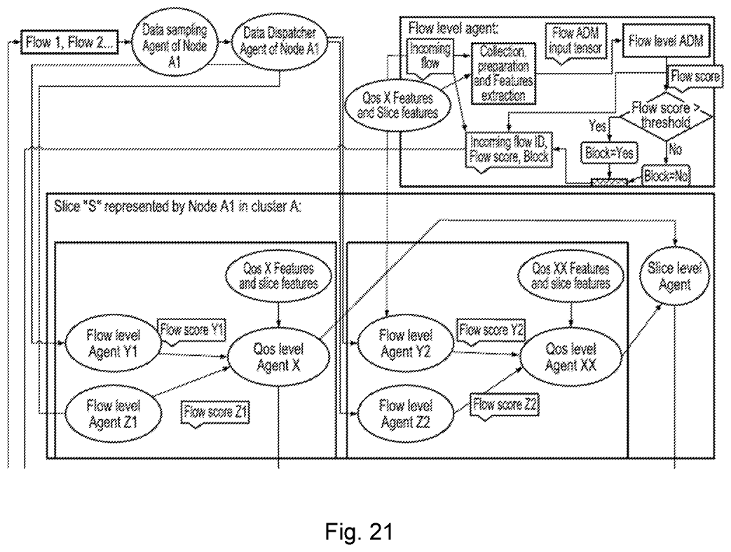

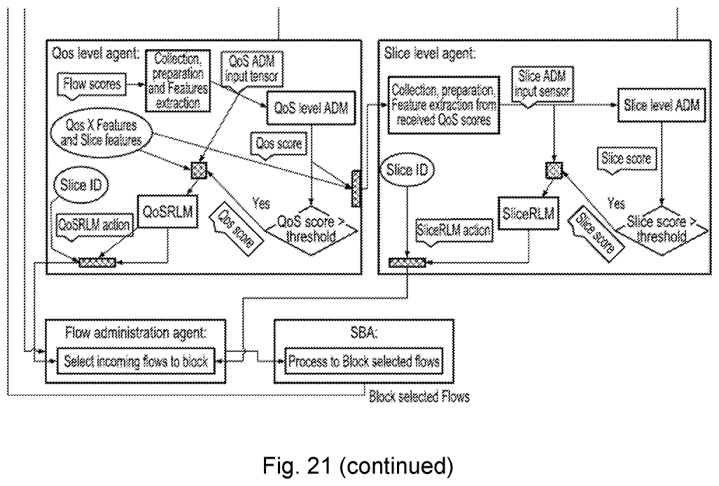

3.4.2. “Flow administration node” Samples from the probability distribution (generated above) the smallest set of flows to block for which the sum of the flow scores of the selected flows is as close as possible to the value of QoSRLM action and then initiates the process to block the selected flows.
3.5. Regardless of whether or not the QoS level node has detected an attack attempt or not, it sends to its Slice level node:
   The generated score (QoS score)
   The Slice ID
   The QoS's ID
4. During each “Slice waiting window” of predefined number of time units, for each tuple (Slice ID, QoS ID), the Slice level node:
   4.1. Using the received QoS scores, extracts features using DCCFEM module.
   4.2. The extracted features, along with the corresponding QoS' features and the slice's features, will generate the input tensor for the Slice level ADM.
   4.3. Taking the Slice ADM input tensor as input for the Slice level ADM, the slice node detects if there is an anomaly (possible attempt of attack) or not for the whole Slice and generates “Slice score” (as illustrated in FIG. 21).
   4.4. If the score corresponds to a possible attempted attack (above a threshold value), Slice level node sends an alert (defensive instruction), to “Flow administration node”, to take defensive action such as blocking, with respect to Y flows (of the same Slice).
      These Y flows are selected as follows:
4.4.1. Using a trained Reinforcement learning model (SliceRLM, trained as illustrated in FIG. 24 below), which receives as input the Slice ADM input and Slice score. As output, the model returns a real number “SliceRLM action” which corresponds to an amount by which the sum of the received flow scores should be reduced in order to reduce the generated “Slice score” below a “Slice attack attempt” threshold. The reward of the RL model is given by:

Reward=Slice attack attempt threshold−new Slice score after blocking selected flows (5)
4.4.2. Slice node sends “SliceRLM action” to “Flow administration node” along with its ID, Slice ID and QoS ID.
4.4.3. Flow administration node selects all flows (of the of the relevant slice and QoS which have been processed by one of the Slice node' QoS level nodes) with “last update time” within the last “QoS waiting window +Slice waiting window” time units.
4.4.4. The Y flows to block are selected based on their flow's score and their QoS features. In the following example, the QoS feature “Priority level” is included in calculating the block probability, however, additional or alternative features could also be considered. To avoid excessive blocking of the same flow, a “block probability” may be used to make the selection stochastic, where block probability is equal to:

$$block probability for flow ( i ) = \frac{( \frac{flow {( i )}^{′} s blocking factor \times flow {( i )}^{′} score}{flow {( i )}^{′} {sQoS}^{′} priority} )}{{\sum }_{j = 1}^{Y} ( \frac{flow {( j )}^{′} s blocking factor \times flow {( j )}^{′} s score}{flow {( j )}^{′} {sQoS}^{′} priority} )} \qquad ( 6 )$$

4.4.5. The flow administration node samples from the probability distribution (generated above) the smallest set of flows to block for which the sum of the flow scores of the selected flows is as close as possible to the value of SliceRLM action, and then initiates the process to block the selected flows.
4.5. Regardless of whether or not the Slice level node has detected an attack attempt, it sends “slice message” to Cluster node. This message includes:
   The Slice ID
   QoS ID
   The generated score (Slice score)
   Current timestamp.

FIG. 21 illustrates interaction between Flow level, QoS level and Slice level nodes of a given RAN node, as described above.
5. In its turn, the Cluster node, on receiving a slice message:
   5.1. Generates a “cluster message” which contains the Cluster's ID and the slice message content.
   5.2. Sends the cluster message to the local node.
6. Each “Local waiting window” of predefined number of time units, for each tuple (Slice ID and QoS ID), the Local level node performs the following steps:
   6.1. Selects clusters messages with “current timestamp” within the last “local waiting window”.
   6.2. Extracts features from the received slice scores using the DCCFEM module and uses the extracted features (together with the corresponding Slice and QoS features) to generate a Local Slice ADM input tensor.
   6.3. Uses the generated ADM input tensor as input for the Local Slice level ADM, and detects whether or not an anomaly consistent with an attack attempt is present for the whole Slice in the whole local area by outputting from the ADM a “local Slice score”.
   6.4. If the score corresponds to a possible attempted attack (above a threshold value), the Local level node:
      6.4.1. Uses a trained Reinforcement learning model LocalSliceRLM, which receives as input the Slice ADM input and “local Slice score”. As output, the model returns a real number “LocalSliceRLM action” which corresponds to an amount by which the sum of the received flow scores should be reduced in order to reduce the generated “local Slice score” below a “local Slice attack attempt” threshold. The reward of the RL model is given by:

Reward=Local Slice attack attempt threshold−new Local Slice score after blocking selected flows (7)
6.4.2. Calculates the sum of Slice scores received from cluster nodes in the local area.
6.4.3. Calculates the sum of Slice scores sent by each cluster node.
6.4.4. Calculates the “cluster ratio” for each cluster. For C clusters:

cluster ratio (i)=sum slice scores (clusterᵢ)/Σₖ₌₁^{C} sum slice scores (clusterₖ) (8)
6.4.5. For each cluster(i), if cluster ratio (i)>0, local node calculates:

cluster(i) share=LocalSliceRLM action×cluster ratio (i) . . . (9)
6.4.6. At this step, the local node sends (Slice ID, QoS ID, cluster(i) share) to the corresponding cluster node.
6.4.7. In its turn, cluster node forwards the Slice ID, QoS ID and “cluster (i) share” to the “Flow administration node”. The flow administration node considers “cluster (i) share” as “SliceRLM action” and follows the steps set out in 4.4.2 to 4.4.5.
6.5. Regardless of whether or not Local node has detected an attack attempt, it sends “Local slice message” to Regional node. This message includes:
   The local node ID
   Local Slice score
   The Slice ID
   The QoS ID
   Current timestamp.
7. Each “Regional waiting window” of predefined number of time units, for each tuple (Slice ID, QoS ID), Regional level node performs the following steps:
   7.1. Selects local nodes messages with “current timestamp” within the last “Regional waiting window”.
   7.2. Using the received Local slice scores, extracts features using DCCFEM module and use the extracted features (in addition to the corresponding Slice and QoS features) to generate a Regional Slice ADM input tensor.
   7.3. Taking the Regional Slice ADM input tensor as input for the Regional Slice level ADM, the regional node detects if there is an anomaly (possible attempt of attack) or not for the whole Slice in the whole region and generates a “regional Slice score”.
   7.4. If the score corresponds to a possible attempted attack (above a threshold value), the Regional level node:
      7.4.1. Uses a trained Reinforcement learning model RegionalSliceRLM, which receives as input the Regional Slice ADM input and “regional Slice score”. As output, the model returns a real number “regionalSliceRLM action” which corresponds to an amount by which the sum of the received flow scores should be reduced in order to reduce the generated “regional Slice score” below a “regional Slice attack attempt” threshold. The reward of the RL model is given by:

Reward=Regional Slice attack attempt threshold−new regional Slice score after blocking selected flows (10)
7.4.2. Calculates the sum of Local Slice scores received from local nodes.
7.4.3. Calculates the sum of Slice scores sent by each local node.
7.4.4. Calculates the “local ratio” for each local node. For L local nodes:

local ratio (i)=sum local slice scores (local nodeᵢ)/Σₖ₌₁^{L} sum local slice scores (local nodeₖ) (11)
7.4.5. For each local node (i), if local ratio (i)>0, the regional node calculates:

local node(i) share=regionalSliceRLM action×localratio (i) (12)
7.4.6. At this step, regional node sends (Slice ID, QoS's ID, local node(i) share) to the corresponding local node.
7.4.7. In its turn, the local node considers the received local node(i) share as “LocalSliceRLM action” and follows the steps set out at 6.4.2 to 6.4.7.
7.5. Regardless of whether or not the Regional node has detected an attack attempt, it sends a “Regional slice message” to the Cloud level node. This message includes:
   The Regional node ID
   The Slice ID
   The QoS ID
   The generated score (Regional Slice score)
   Current timestamp.
8. Each “Cloud waiting window” of predefined number of time units, for each tuple (Slice ID, QoS ID), the Cloud level node performs the following steps:
   8.1. Selects regional node messages with “current timestamp” within the last “Cloud waiting window”.
   8.2. From Regional Slice scores, extracts features using DCCFEM module and uses the extracted features (in addition to the corresponding Slice and QoS features) to generate a Cloud Slice ADM input tensor.
   8.3. Taking the Cloud Slice ADM input tensor as input for the Cloud Slice level ADM, the node detects if there is an anomaly (possible attempt of attack) or not for the whole Slice over all regions and generates a “cloud Slice score”.
   8.4. If the score corresponds to a possible attempted attack (above a threshold value), the cloud level node:
      8.4.1. Uses a trained Reinforcement learning model CloudSliceRLM, which receives as input the Cloud Slice ADM input and “Cloud Slice score”. As output, the model returns a real number “CloudSliceRLM action” which corresponds to an amount by which the sum of the received flow scores should be reduced in order to reduce the generated “Cloud Slice score” below a “Cloud Slice attack attempt” threshold. The reward of the RL model is given by:

Reward=Cloud Slice attack attempt threshold−new cloud Slice score after blocking selected flows (13)
8.4.2. Calculates the sum of Regional Slice scores received from different regional nodes.
8.4.3. Calculates the sum of Slice scores sent by each regional node.
8.4.4. Calculates the “region ratio” for each regional node. For R regional nodes:

region ratio (i)=sum region slice scores (regional nodeᵢ)/Σₖ₌₁^{R} sum region slice scores (regional nodeₖ) (14)
8.4.5. For each Regional node (i), if region ratio (i)>0, cloud node calculates:

regional node(i) share=cloudSliceRLM action×regionratio (i) (15)
8.4.6. At this step, cloud node sends (Slice ID, QoS ID, regional node(i) share) to the corresponding regional node.
8.4.7. In its turn, the regional node considers the received regional node(i) share as “RegionalSliceRLM action”, and follows the steps set out above at 7.4.2 to 7.4.7.

### Data Drift:

During flow level node life, each flow level node may run data drift after each predefined window of time to check if there is a drift or evolution in the data of incoming traffic flows by generating a data drift score. The flow level nodes then send the data drift score, along with the corresponding slice ID and QoS ID, to the next level node (QoS level node). In its turn, the QoS level node, for each tuple (slice ID, QoS ID), after each predefined window of time, generates features such as average, standard deviation, minimum, maximum, sum, median, skewness, kurtosis, 5%, 25%, 75%, 95% quantiles, entropy, etc. of the received data drift scores and then sends the calculated features, along with the Slice features, QoS features and the QoS node ID to the cluster node. The cluster node will forward this information to the cloud node which decides, based on a score (generated by a model) whether or not to re-train the ADM and RL models for the flow nodes of the corresponding QoS node according to whether or not the score is greater than a predefined threshold. The model that generates the score to determine retraining or not could be a neural network, a regression model, etc. that receives as input the features forwarded by the cluster node (statistical, slice and QoS features mentioned above) and outputs a real number between [0,1]. The cloud node may take also into consideration scores generated after processing other QoS nodes' inputs of the same (or different) cluster, local or regional area to decide either to retrain or not the ADM and RL models. This decision could be based on a regression model, ML model or any other model that receives as input the features (such as average, std, min, max, . . . ) generated from the received scores within a window of time, along with the corresponding slice and QoS features, and outputs a score to represent the probability that ADM and RL models should be re-trained or not. The cloud node's role in the data drift process could be played by nodes in lower levels (for example, Regional node for data drift process within its regional area, local node for its local area etc.). If the models are re-trained, their new versions are then propagated to all corresponding nodes.

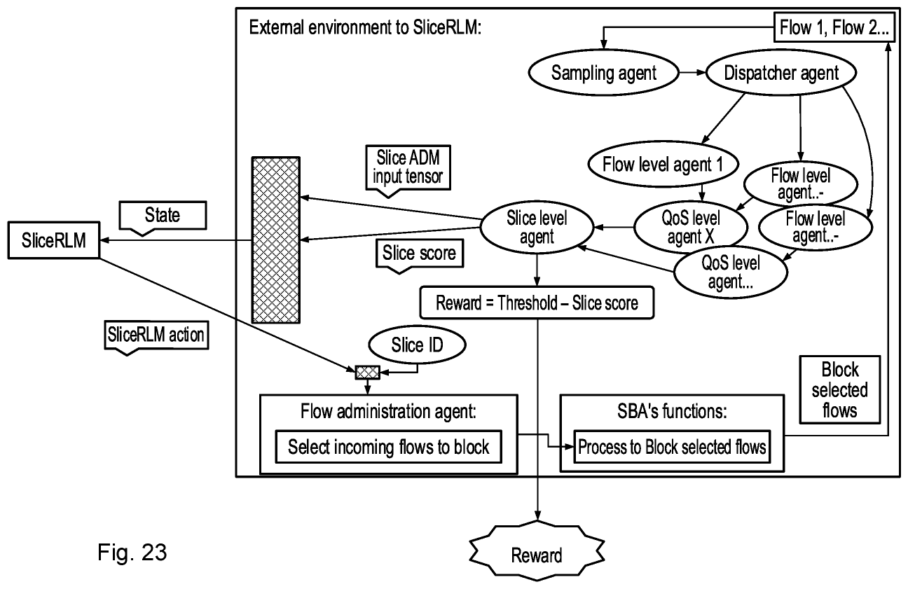

As an example of how to train RL models, training of the QoS level detection node RL model (QoSRLM) is illustrated in FIG. 22, and training of the Slice level node RL model (SliceRLM) is illustrated in FIG. 23. The state of the environment input to the RL models comprises the input tensors discussed above together with the anomaly detection score generated by the relevant node. Reward is calculated based on minimising a difference between the threshold for detection of anomalous behaviour and the new anomaly detection score following reduction of the sum of the obtained anomaly detection scores by the action amount.

Examples of the present disclosure provide a system, methods and nodes that approach the task of detecting and dealing with distributed attacks on an edge communication network by considering anomalous behaviour at different hierarchical levels and on different geographical scales. Detection nodes are operable to detect anomalous behaviour on their hierarchical level, and to contribute to anomalous behaviour detection on higher hierarchical levels through the reporting of anomaly detection scores. Lower level nodes receive user data flows as input, and higher level nodes receive scores generated by lower level nodes. In addition to anomaly detection, higher level nodes may also use RL models to assist in the stochastic selection of user flows that should be subject to defensive actions so as to defend against potential distributed attacks. The stochastic selection may be based on flow features and parameters including QoS and Network slice features. Examples of the present disclosure may also detect data drift in incoming user data, and consequently trigger appropriate retraining of ML models to ensure efficacy of anomaly detection and flow selection for defensive action. Examples of the present disclosure may exploit virtualisation technologies and be implemented in a distributed manner across several Radio Access and Core network nodes, as discussed above.

Examples of the present disclosure thus offer an approach that facilitates detection of anomalies at multiple hierarchical levels. Anomalies which may be indicative of attacks can be detected on the flow level as well as at higher levels including QoS, slice etc. Such attacks could target a specific Slice in a specific geographical area, or many areas of different geographical extent. The approach of the present disclosure ensures low latency as UE traffic is not held temporarily until the system detects no anomalies, but rather is assessed in real time. In addition, anomaly detection is performed on the basis of sampling from the incoming traffic, as opposed to copying the entire traffic, which would take considerably longer. Methods according to the present disclosure also ensure flexibility and efficiency, allowing for deployment of detection nodes in a manner and at a level that is appropriate for a given deployment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. (canceled)

2. A computer implemented method for facilitating detection of anomalous behaviour in an edge communication network, the method being performed by a detection node that is a component of a hierarchical system of detection nodes deployed in the edge communication network, the method comprising:
obtaining samples of an incoming traffic flow from a wireless device to the communication network;
using a Machine Learning, ML, model to generate, based on the received samples, an anomaly detection score representative of a probability that the incoming traffic flow is associated with anomalous behaviour in the communication network;
providing the anomaly detection score to a detection node at a higher hierarchical level of the system; and
if the anomaly detection score is above a threshold value, initiating a defensive action with respect to the incoming traffic flow.

3. The method as claimed in claim 2, wherein using an ML model to generate, based on the received information, an anomaly detection score representative of a probability that the incoming traffic flow is associated with anomalous behaviour in the communication network comprises:
generating an input feature tensor from the obtained samples; and
inputting the input feature tensor to the ML model, wherein the ML model is operable to process the input feature tensor in accordance with its model parameters, and to output the anomaly detection score.

4. The method as claimed in claim 3, wherein generating an input feature tensor from the obtained samples comprises:
performing a feature extraction process on the obtained samples, and adding the extracted features to the input tensor.

5. The method as claimed in claim 4, wherein generating an input feature tensor from the obtained samples further comprises:
adding to the input tensor at least one of:
a Quality of Service parameter associated with the incoming traffic flow;
a Network Slice parameter of a Network Slice to which the incoming traffic flow belongs.

6. The method as claimed in claim 3, wherein the ML model is further operable to output a classification of anomalous behaviour with which the incoming traffic flow is associated.

7. The method as claimed in claim 2, further comprising:
providing the anomaly detection score to an administration node of the hierarchical system.

8. The method as claimed in claim 2, further comprising:
generating a data drift score for the incoming data flow, wherein the data drift score is representative of evolution of a statistical distribution of the obtained samples of the incoming data flow over a data drift window; and
providing the data drift score to a detection node at a higher hierarchical level of the system.

9. The method as claimed in claim 8, wherein generating a data drift score for the incoming data flow comprises:
for each of a plurality of samples of the incoming traffic flow, the samples obtained at different time instances during the data drift window:
calculating a change in a statistical distribution of the samples from the previous time instance; and
using the calculated changes in statistical distribution to generate the data drift score for the incoming data flow.

10. The method as claimed in claim 9, wherein using the calculated changes in statistical distribution to generate the data drift score for the incoming data flow comprises:
inputting the calculated changes in statistical distribution to a trained ML model, wherein the ML model is operable to process the calculated changes in statistical distribution in accordance with its model parameters, and to output the data drift score.

11. The method as claimed in claim 2, wherein initiating a defensive action with respect to the incoming traffic flow comprises:
providing a defensive instruction to an administration node of the hierarchical system.

12. A computer implemented method for facilitating detection of anomalous behaviour in an edge communication network, the method being performed by a detection node that is a component of a hierarchical system of detection nodes deployed in the edge communication network, the method comprising:
obtaining, from a plurality of detection nodes at a lower hierarchical level of the system, a plurality of anomaly detection scores, each anomaly detection score generated by a lower level detection node for a respective at least one incoming traffic flow from a wireless device to the communication network;
using a Machine Learning, ML, model to generate, based on the obtained anomaly detection scores, a distributed anomaly detection score representative of a probability that the incoming traffic flows are associated with a distributed pattern of anomalous behaviour in the communication network; and
if the distributed anomaly detection score is above a threshold value, initiating a defensive action with respect to at least one of the incoming traffic flows.

13. The method as claimed in claim 12, wherein using an ML model to generate, based on the obtained anomaly detection scores, a distributed anomaly detection score representative of a probability that the incoming traffic flows are associated with a distributed pattern of anomalous behaviour in the communication network comprises:
generating an input feature tensor from the obtained anomaly detection scores; and
inputting the input feature tensor to the ML model, wherein the ML model is operable to process the input feature tensor in accordance with its model parameters, and to output the distributed anomaly detection score.

14. The method as claimed in claim 13, wherein generating an input feature tensor from the obtained anomaly detection scores comprises:
performing a feature extraction process on the obtained anomaly detection scores, and adding the extracted features to the input tensor.

15. The method as claimed in claim 14, wherein generating an input feature tensor from the obtained anomaly detection scores further comprises:
adding to the input tensor at least one of:
a Quality of Service parameter associated with the incoming traffic flows;
a Network Slice parameter of a Network Slice to which the incoming traffic flows belong.

16. The method as claimed in claim 13, wherein the ML model is further operable to output a classification of distributed anomalous behaviour with which the incoming traffic flows are associated.

17. (canceled)

18. The method as claimed in claim 12, wherein initiating a defensive action with respect to at least one of the incoming traffic flows comprises:
using a Reinforcement Learning, RL, model to determine an anomaly reduction action, based on the obtained anomaly detection scores and on the generated distributed anomaly detection score; and
wherein the anomaly reduction action comprises a reduction in the sum of the obtained anomaly detection scores that is predicted to cause the distributed anomaly detection score to fall below the threshold value.

19. The method as claimed in claim 18, wherein using an ML model to generate, based on the obtained anomaly detection scores, a distributed anomaly detection score representative of a probability that the incoming traffic flows are associated with a distributed pattern of anomalous behaviour in the communication network comprises:
generating an input feature tensor from the obtained anomaly detection scores; and
inputting the input feature tensor to the ML model, wherein the ML model is operable to process the input feature tensor in accordance with its model parameters, and to output the distributed anomaly detection score; and
wherein using an RL model to determine an anomaly reduction action, based on the obtained anomaly detection scores and on the generated distributed anomaly detection score, comprises:
inputting to the RL model the generated input feature tensor and the generated distributed anomaly detection score.

20. The method as claimed in claim 18, wherein using an RL model to determine an anomaly reduction action based on the obtained anomaly detection scores and on the generated distributed anomaly detection score comprises:
inputting a representation of the obtained anomaly detection scores and the generated distributed anomaly detection score to the RL model, wherein the RL model is operable to process the input feature tensor in accordance with its model parameters, and to select an amount which, if the sum of the obtained anomaly detection scores is reduced by that amount, is predicted to result in the distributed anomaly detection score falling below the threshold value.

21.-28. (canceled)

29. The method as claimed in claim 12, further comprising:
providing the distributed anomaly detection score to a detection node at a higher hierarchical level of the system.

30. The method as claimed in claim 12, further comprising:
obtaining, from a detection node at a higher hierarchical level of the system, a compound area anomaly reduction action that applies to a plurality of geographic areas;
for each geographic area to which at least one of the obtained distributed anomaly detection scores relates:
generating an area anomaly reduction action which comprises an amount of the compound anomaly reduction action that is to be achieved by defensive action with respect to incoming traffic flows that are directed to radio access nodes in that geographic area; and
providing the generated area anomaly reduction actions to detection nodes at a lower hierarchical level of the system.

31. The method as claimed in claim 12, further comprising:
obtaining, from a plurality of detection nodes at a lower hierarchical level of the system, a plurality of data drift scores;
generating a system data drift score from the plurality of obtained data drift scores; and
if the system data drift score is above a threshold value, triggering retraining of ML models in detection nodes of the system; and
wherein the obtained data drift scores are representative of evolution of a statistical distribution of samples of incoming data flows obtained by detection nodes at a lower hierarchical level of the system over a data drift window.

32.-44. (canceled)

45. A detection node for facilitating detection of anomalous behaviour in an edge communication network, the detection node being a component of a hierarchical system of detection nodes deployed in the edge communication network, the detection node comprising processing circuitry configured to cause the detection node to:
obtain samples of an incoming traffic flow from a wireless device to the communication network;
use a Machine Learning, ML, model to generate, based on the received samples, an anomaly detection score representative of a probability that the incoming traffic flow is associated with anomalous behaviour in the communication network;
provide the anomaly detection score to a detection node at a higher hierarchical level of the system; and
if the anomaly detection score is above a threshold value, initiate a defensive action with respect to the incoming traffic flow.

46. (canceled)

47. A detection node for facilitating detection of anomalous behaviour in an edge communication network, the detection node being a component of a hierarchical system of detection nodes deployed in the edge communication network, the detection node comprising processing circuitry configured to cause the detection node to:
obtain, from a plurality of detection nodes at a lower hierarchical level of the system, a plurality of anomaly detection scores, each anomaly detection score generated by a lower level detection node for a respective at least one incoming traffic flow from a wireless device to the communication network;
use a Machine Learning, ML, model to generate, based on the obtained anomaly detection scores, a distributed anomaly detection score representative of a probability that the incoming traffic flows are associated with a distributed pattern of anomalous behaviour in the communication network; and
if the distributed anomaly detection score is above a threshold value, initiate a defensive action with respect to at least one of the incoming traffic flows.

48.-50. (canceled)
